(19) United States
(12) Patent Application Publication
(10) Pub. No.: US 2026/0252006 A1
(43) Pub. Date: Aug. 27, 2026

(54) IMAGE FORMING APPARATUS

(71) Applicant: CANON KABUSHIKI KAISHA, Tokyo (JP)

(72) Inventor: NAOTO WATANABE, Chiba (JP)

(21) Appl. No.: 19/541,523

(22) Filed: Feb. 17, 2026

(30) Foreign Application Priority Data
Feb. 21, 2025 (JP) 2025-027418

(51) Int. Cl. G03G 15/20; G03G 15/00

(52) U.S. Cl. CPC G03G 15/2028; G03G 15/2025; G03G 15/2039; G03G 15/2046; G03G 15/205; G03G 15/6585

(57) ABSTRACT

An image forming apparatus includes a storage in which information on a target temperature of a fixing portion is stored corresponding to a type of a recording material. The target temperature includes a temperature range for each type. A controller, when executing a job for forming a toner image on a plurality of recording materials including first and second recording materials of first and second types, respectively, before the toner image is formed on the first and second recording materials, acquires the types of the first and second recording material and acquires first and second temperature ranges corresponding to the first and second types, respectively. In a case in which there is an overlapped temperature range where the first and second temperature ranges overlap each other, the controller sets the target temperature at a temperature in the overlapped temperature range.

### BACKGROUND

### Field of the Technology

The present invention relates to an image forming apparatus provided with a fixing device for fixing a toner image on a recording material.

### Description of the Related Art

Image forming apparatuses that form images on recording materials using an electrophotographic printer engine are, for example, sometimes used as image forming apparatuses called on-demand printers for printing a small number of booklets. When printing a booklet or the like, for example, the product is completed as follows. That is, in a printer unit of an image forming apparatus, printing is performed continuously on a recording material for the cover which is mainly coated paper or thick paper, and on a recording material for the text which is mainly thin paper or plain paper. Further, a post-processing device connected to a subsequent stage of the printer unit finishes the bound product by saddle stitching or gluing.

The electrophotographic printer engine includes a fixing device for fixing an unfixed toner image on the recording material. To fix the unfixed toner image on the recording material, a heat amount that takes into consideration the amount of heat absorbed by the recording material is required. Therefore, it is common to change a temperature (fixing temperature) of the fixing device in accordance with the recording material.

By the way, when printing is continuously performed on different types of recording material for the cover and the text, such as in the case of booklet printed product (bookbinding products), a waiting time may be required for changing a fixing temperature when switching between the recording materials for the cover and the text.

In contrast, the following method is proposed in Japanese Laid-Open Patent Application (JP-A) Publication No. 2023-105654. That is, at the start of a job, information regarding the type of the recording material associated with each page is acquired for a predetermined number of pages prior to image formation. Further, by selecting an optimal target temperature table from a plurality of target temperature tables, such as thick paper priority or thin paper priority, depending on the types of recording materials that are mixed, the waiting time for an operation that waits until the fixing temperature is switched (hereinafter also referred to as “temperature switching operation”) is minimized.

### SUMMARY

An image forming apparatus comprising: an image forming portion configured to form a toner image on a recording material; a fixing portion configured to apply heat to the recording material on which the toner image is formed and to fix the toner image onto the recording material; a storage portion in which information on a target temperature of the fixing portion is stored corresponding to a type of the recording material; an acquiring portion configured to acquire the information on the type of the recording material on which the toner image is formed; and a controller configured to set the target temperature required to fix the toner image on the recording material based on the information on the type acquired by the acquiring portion and the information on the target temperature stored in the storage portion, wherein in the storage portion, information on a temperature range from a lower limit value to an upper limit value of the target temperature is stored corresponding to the type of the recording material, and wherein the controller, when executing a job for forming the toner image on a plurality of recording materials including a first recording material of a first type and a second recording material, succeeding to the first recording material, of a second type, before the toner image is formed on the first and the second recording materials, acquires the information on the types of the first and the second recording material and acquires the information on a first temperature range which is the temperature range corresponding to the first type and a second temperature range which is the temperature range corresponding to the second type, and wherein the controller sets the target temperature at a temperature within the overlapped temperature range in a case in which there is an overlapped temperature range where the first temperature range and the second temperature range overlap each other.

Further features of the present disclosure will become apparent from the following description of exemplary embodiments with reference to the attached drawings.

### BRIEF DESCRIPTION OF THE DRAWINGS

FIG. 1 is a sectional view showing a schematic block of an image forming system.

FIG. 2 is a block diagram showing a control configuration of the image forming system.

FIG. 3 is a schematic view of an operation display device.

FIG. 4 is an explanatory diagram of a target temperature table.

FIG. 5 is an explanatory diagram of an example of a fixing temperature control (pattern with a same sheet type).

FIG. 6 is an explanatory diagram of a pattern with different sheet types.

FIG. 7 is an explanatory diagram of an example of the fixing temperature control (pattern with an overlapped fixing temperature range).

FIG. 8 is an explanatory diagram of an example of the fixing temperature control (pattern with the non-overlapped fixing temperature range).

FIG. 9 is an explanatory diagram of an example of the fixing temperature control (pattern for outputting more than 10 pages).

FIG. 10 is an overall flow chart diagram of a prefetching fixing control.

FIG. 11A is a flow chart diagram of a set temperature determining process.

FIG. 11B is a flow chart diagram of the set temperature determining process.

FIG. 12 is a flow chart diagram of a temperature change upper limit checking process.

FIG. 13 is an explanatory diagram of a control data.

FIG. 14 is a sectional view showing a schematic block of a fixing portion.

Parts (a), (b), and (c) of FIG. 15 are explanatory diagrams of an example of transitions in the control data for a fixing temperature control (pattern with the same sheet type).

Parts (a), (b), (c), and (d) of FIG. 16 are explanatory diagrams of the transitions in the control data for the fixing temperature control (pattern with the overlapped fixing temperature range).

Parts (a), (b), (c), and (d) of FIG. 17A are explanatory diagrams of the transitions in the control data for the fixing temperature control (pattern with the non-overlapped fixing temperature range).

Parts (e), (f), (g), and (h) of FIG. 17B are explanatory diagrams of the transitions in the control data for the fixing temperature control (pattern with the non-overlapped fixing temperature range).

FIG. 18 is an explanatory diagram of the target temperature table of the prior art.

### DESCRIPTION OF THE EMBODIMENTS

An image forming apparatus pertaining to the present invention will be described below in further detail with reference to the drawings.

### Embodiment 1

### Overall Configuration

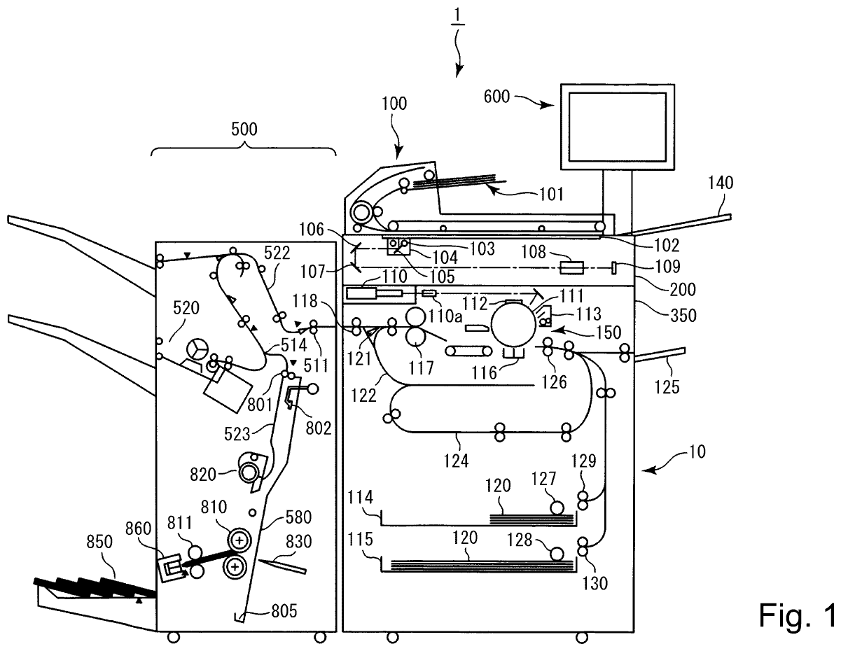

FIG. 1 is a longitudinal sectional view showing a schematic block of a main part of an image forming system 1 according to this embodiment. The image forming system 1 is provided with an image forming apparatus 10 and a finisher 500. The image forming apparatus 10 forms an image on a sheet 120, which is a sheet-like recording material, by an electrophotographic image forming process. The image forming apparatus 10 is provided with an image reader 200 that reads the image from a document, and a printer 350 that forms the image read by the image reader 200 on the sheet 120. Further, a document feeding device 100 is attached to the image reader 200. Further, the image forming apparatus 10 is provided with an operation display device 600.

Incidentally, although recording material is called sheet or paper, the recording material is not limited to being composed of paper, but also includes material other than paper, such as plastic sheets and synthetic paper, or material containing material other than paper. Further, a type of the recording material (sheet) includes classifications based on arbitrary information that can distinguish the recording material, such as attributes (so-called paper type categories) based on general characteristics such as plain paper, fine (quality) paper, coated paper, thick paper, and thin paper, numerical values or numerical ranges such as basis weight and thickness, and brands (including manufacturers, product numbers, and the like). Generally, the type of the recording material is often specified by the basis weight (or thickness) and paper type category (coated paper, fine paper, and the like).

The document feeding device 100 feeds a document set on a document tray 101 with a reading surface to be read by the image reader 200 facing upward, one by one sequentially from the first page to the left direction in FIG. 1. The document feeding device 100 then conveys the document through a curved path from the left side in FIG. 1 to the right side in FIG. 1 on a platen glass 102 of the image reader 200. At this time, the document is conveyed through a predetermined skim-through reading position. Thereafter, the document feeding device 100 discharges the document toward a discharge tray 140 outside the platen glass 102.

The skim-through reading position is a predetermined reading position on the platen glass 102 corresponding to a predetermined position where a scanner unit 104 of the image reader 200 is fixed (stopped).

When the document passes the skim-through reading position on the platen glass 102 from the left side to the right side in FIG. 1, the image of the document is read by the scanner unit 104 held at a position corresponding to the skim-through reading position. When the document passes through the skim-through reading position, light is irradiated from a lamp 103 of the scanner unit 104 onto the reading surface of the document, and the light reflected from the document is guided to a lens 108 via mirrors 105, 106, and 107. The light passing through the lens 108 forms the image on an imaging surface of an image sensor 109.

Thus, by conveying the document so that it passes the skim-through reading position from the left side to the right side in FIG. 1, a document reading scan is performed in which a direction perpendicular to a conveyance direction of the document is the main scanning direction, and the conveyance direction is a subscanning direction. That is, when the document passes the skim-through reading position, the document is conveyed in the subscanning direction while the image of the document is read line by line by the image sensor 109 in the main scanning direction, thereby reading the entire image of the document. The image that is optically read by the scanner unit 104 and the image sensor 109 is converted into image data by the image sensor 109 and outputted to the printer 350. The image data output from the image sensor 109 is input to an exposure portion 110 of the printer 350 as a video signal.

The exposure portion 110 of the printer 350 modulates and outputs a laser beam based on the video signal input from the image reader 200. This laser beam is irradiated onto a photosensitive drum 111 as an image bearing member while being scanned by a polygon mirror 110a. The photosensitive drum 111 is uniformly charged in advance by a charger 112. Further, by removing the charge on the portion of the photosensitive drum 111 irradiated with the laser beam, an electrostatic latent image (electrostatic image) corresponding to the scanned laser beam is formed on the photosensitive drum 111. Here, the exposure portion 110 outputs the laser beam so that a correct image (an image that is not a mirror image) is formed at the time of document fixed reading. The electrostatic latent image on the photosensitive drum 111 is visualized (developed) as a developer image (toner image) by a developer (toner) supplied from a developing device 113.

On the other hand, the sheet 120 fed by a pickup roller 127 from an upper cassette 114 provided in the printer 350 is conveyed to a registration roller 126 by a paper feeding roller 129 or the like. Alternatively, the sheet 120 fed by a pickup roller 128 from a lower cassette 115 provided in the printer 350 is conveyed to the registration roller 126 by a paper feeding roller 130 or the like. When a leading end of the sheet reaches the registration roller 126, the registration roller 126 is driven at an arbitrary timing, and the sheet is conveyed between the photosensitive drum 111 and a transfer portion (transfer device) 116 at a timing synchronized with the start of the laser beam irradiation. The developer image formed on the photosensitive drum 111 is transferred to the sheet fed by the action of the transfer portion 116. In this embodiment, the photosensitive drum 111, the charger 112, the exposure portion 110, the developing device 113, the transfer portion 116, and the like constitute an image forming portion 150 which forms the toner image on the recording material (sheet). The sheet onto which the developer image has been transferred is conveyed to a fixing portion (fixing device) 117. The fixing portion 117 applies heat and pressure to the sheet to fix the developer image on the paper. The sheet that has passed through the fixing portion 117 passes through a flapper 121 and a discharge roller 118, and is discharged from the printer 350 to the outside of the image forming apparatus 10 (finisher 500 in this embodiment).

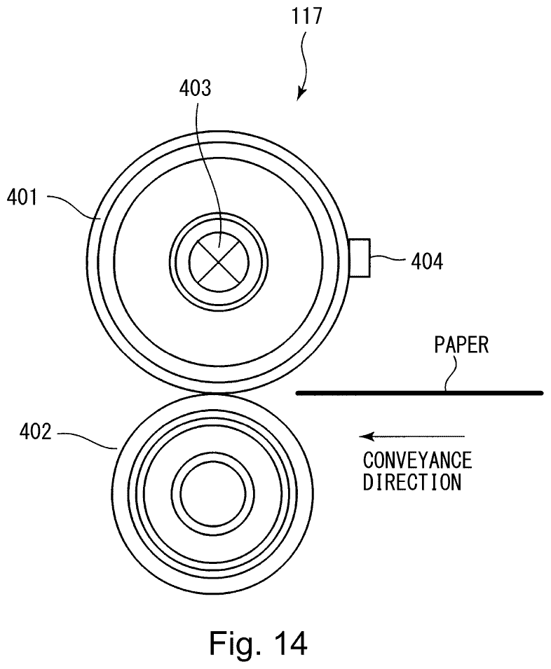

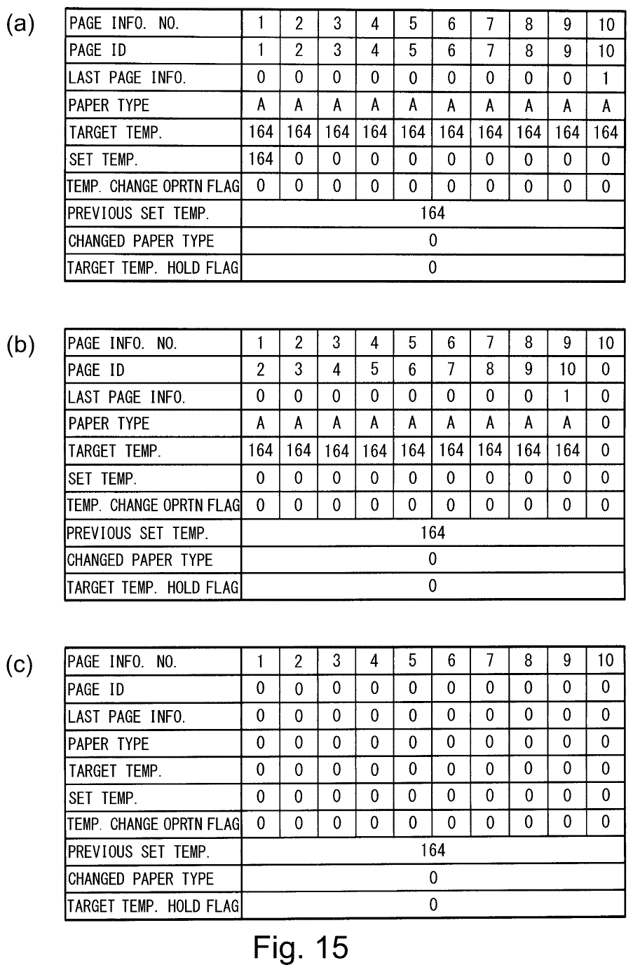

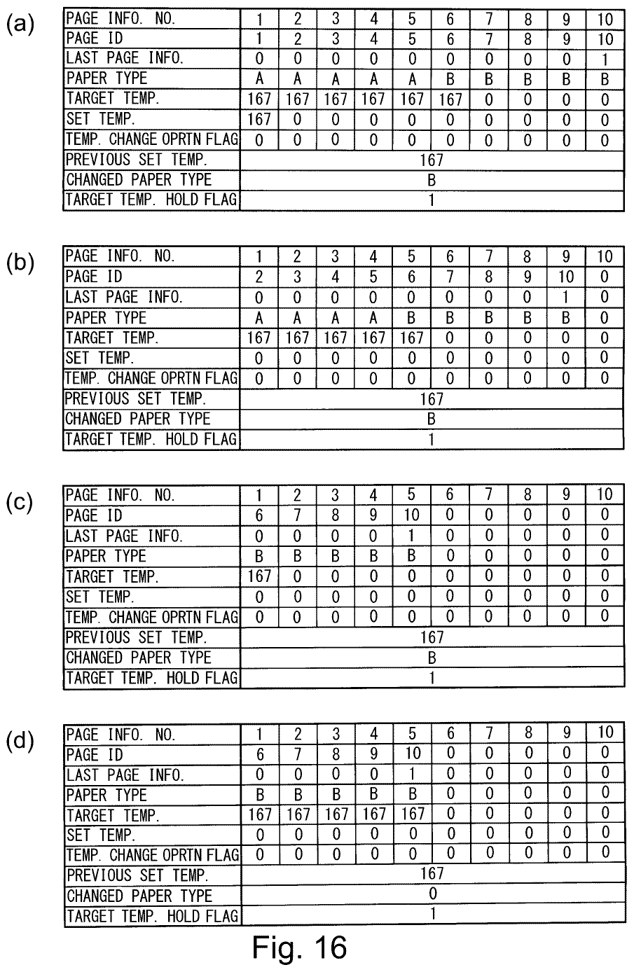

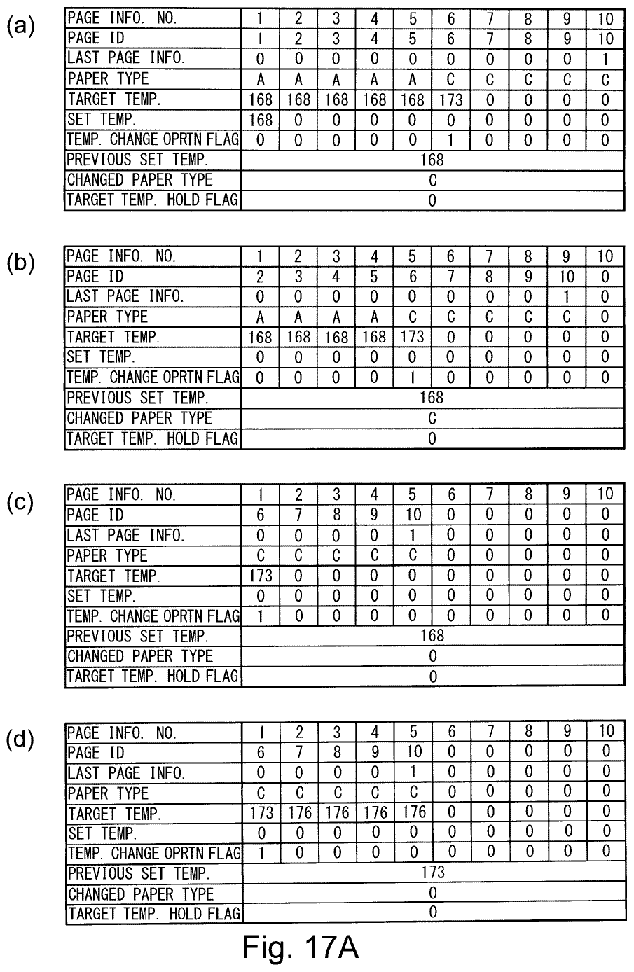

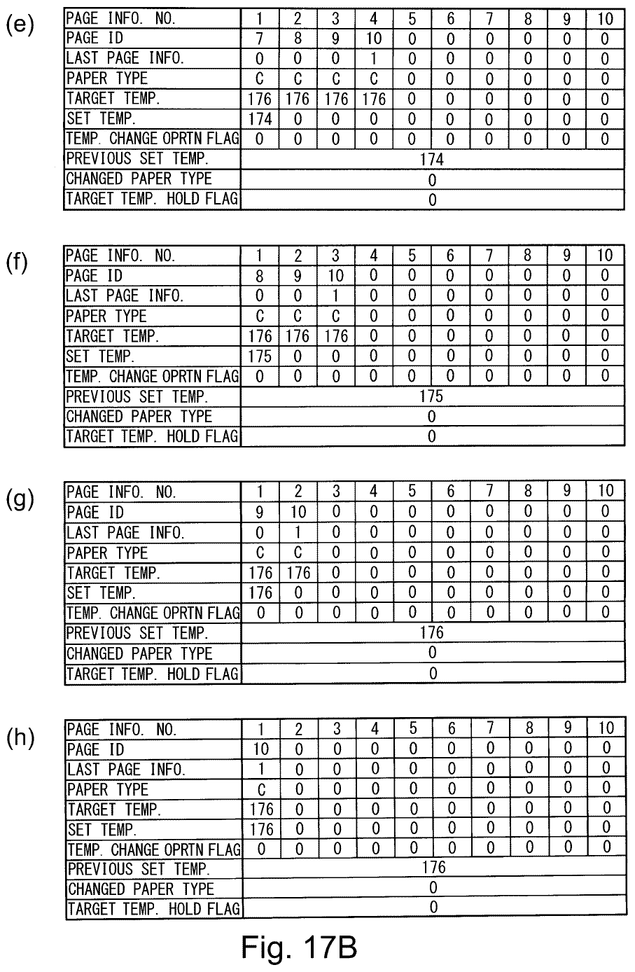

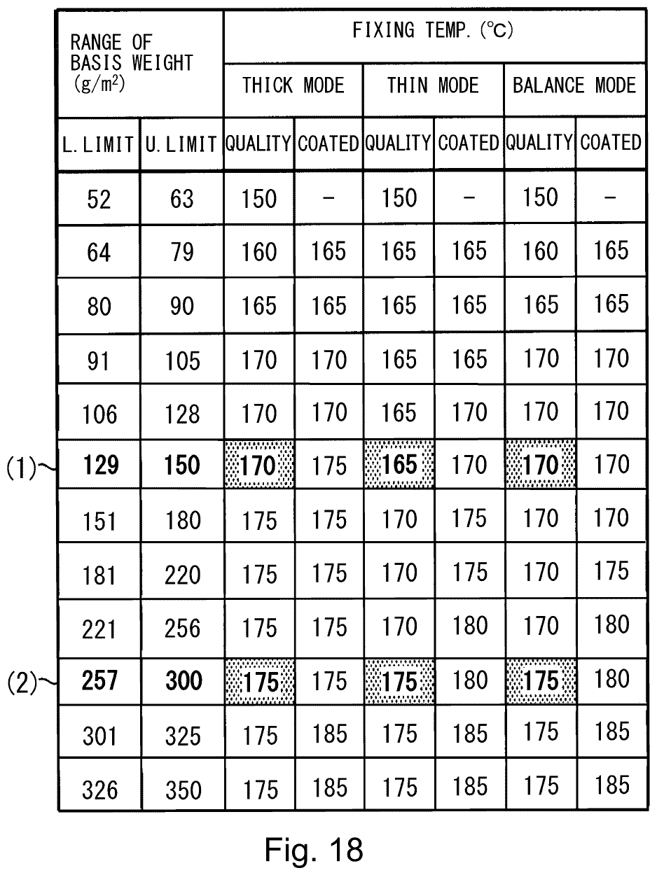

The fixing portion 117 will be further described. FIG. 14 is a sectional view showing a schematic block of the fixing portion 117. The fixing portion 117 is, for example, a roller heating type fixing device. The fixing portion 117 is provided with a heating roller 401 as a heating rotator for melting the toner image formed on the sheet, and a pressure roller 402 as a pressure rotator that presses the heating roller 401. The heating roller 401 is composed of a hollow pipe. A heater 403 is provided as a heat source inside the heating roller 401. The pressure roller 402 is composed of an elastic roller having a core metal, an elastic layer provided on the outer periphery of the core metal, and a release layer provided on the outer periphery of the elastic layer. The pressure roller 402 is rotated by a driving force transmitted from a driving source (not shown).

The heating roller 401 is rotated by the rotation of the pressure roller 402. When the sheet bearing the unfixed toner image passes through a contact portion between the heating roller 401 and the pressure roller 402, the sheet is heated and pressed while being conveyed by the heating roller 401 and the pressure roller 402. A temperature detecting portion 404 composed of a thermistor or the like is provided in contact with or in the vicinity of the outer peripheral surface of the heating roller 401. Based on a detection result of a temperature by the temperature detecting portion 404, the power supplied to the heater 403 is turned on/off by the control of a printer controller 931 (described later) in response to an instruction from a CPU 901 (described later). As a result, the temperature (fixing temperature) of the fixing portion 117 is controlled to be the set temperature. Incidentally, the fixing portion 117 may be configured to have an endless fixing belt as a heating rotator, a heater for heating the fixing belt, a pressure pad for supporting the fixing belt, and a pressure roller as a pressure rotator that is pressed against the pressure pad via the fixing belt. In this case, the heater can be configured to heat the fixing belt via a roller provided to contact an inner peripheral surface of the fixing belt, or can be configured to heat the fixing belt via the pressure pad or to perform a part of the function of the pressure pad.

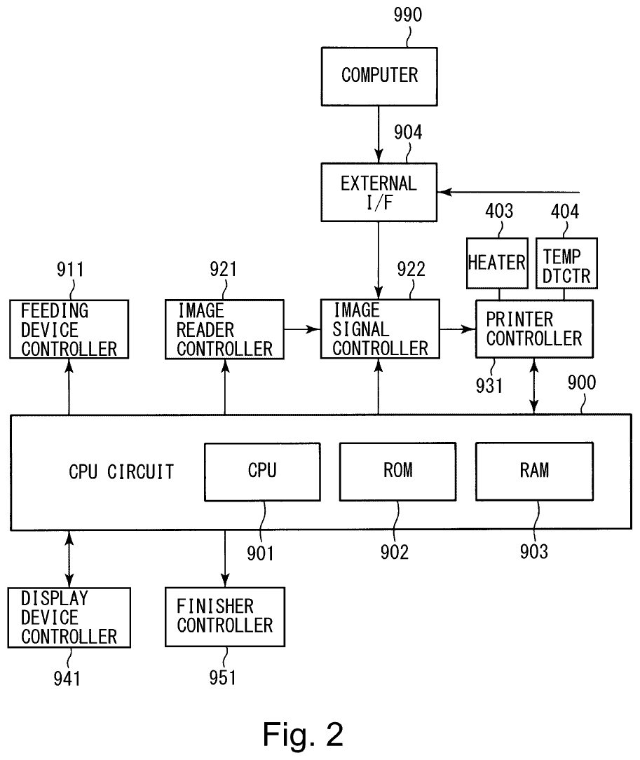

Here, when the sheet is discharged from the printer 350 with its image forming surface facing downward (face down), the sheet that has passed through the fixing portion 117 is once guided into a reversing path 122 by a switching operation of the flapper 121. Then, after a trailing end of the sheet passes through the flapper 121, the sheet is switched back and discharged from the printer 350 by the discharge roller 118. This paper discharge form is called reverse paper discharge. This reverse paper discharge is performed when forming an image sequentially from the first page, for example, when forming an image read using the document feeding device 100, or when forming an image output from a computer 990 (FIG. 2) which is an example of an external device. In the case of reverse paper discharge, the sheet order after the discharge is in correct page order. Further, when a hard sheet such as an OHP sheet is fed from a manual paper feeding portion 125 and the image is formed on this sheet, the sheet is discharged from the printer 350 by the discharge roller 118 with the image forming surface facing upward (face up) without the sheet being guided to the reversing path 122. Further, in a case in which double-sided recording is set for performing image formation on both sides of the sheet, the sheet is guided to the reversing path 122 by the switching operation of the flapper 121, then conveyed to a double-sided conveyance path 124. Thereafter, control is performed to feed the sheet guided to the double-sided conveyance path 124 again between the photosensitive drum 111 and the transfer portion 116 at the timing described above.

The sheet discharged from the printer 350 of the image forming apparatus 10 is sent to the finisher 500.

### Finisher

Next, a configuration of the finisher 500 will be described.

The finisher 500 sequentially takes in the sheets discharged from the image forming apparatus 10 and performs the following post-sheet processing, such as aligning a plurality of taken-in sheets and bundling them into one bundle, stapling processing for binding the trailing end of the bundle of bundled sheets with staples, punching processing for punching the vicinity of the trailing end of the taken-in sheets, sorting processing, non-sorting processing, and bookbinding processing.

The finisher 500 takes in the sheet discharged from the image forming apparatus 10 into the interior by an inlet roller pair 511. The sheet taken inside the finisher 500 by the inlet roller pair 511 is sent to a sort path 522. Further, a switching flapper 514 is disposed on a downstream side of the sort path 522 in the conveyance direction of the sheet. The switching flapper 514 is a flapper that switches between a path to a processing tray 520 and a path to a bookbinding path 523.

The sheet guided to the bookbinding path 523 is conveyed to the bookbinding processing tray 580 via a conveyance roller pair 801. A bookbinding inlet sensor (not shown) is provided midway along the bookbinding path 523. The bookbinding processing tray 580 is provided with a sheet gripping member 802 and a movable sheet positioning member 805. Further, the bookbinding path 523 is also provided with a saddle stitch stapler 820. The finisher 500 is configured to be able to staple a sheet bundle stored in the bookbinding processing tray 580 using the saddle stitch stapler 820. A folding roller pair 810 and a protruding member 830 disposed at an opposite position of the folding roller pair 810 are provided on a downstream side of the saddle stitch stapler 820 in the conveyance direction of the sheet. The protruding member 830 is protruded toward the sheet bundle stored in the bookbinding processing tray 580 so that the sheet bundle stored in the bookbinding processing tray 580 is pushed between the folding roller pair 810. The folding roller pair 810 folds the sheet bundle and conveys the sheet bundle downstream. The folded sheet bundle is guided to the conveyance path and conveyed downstream via a folding conveyance roller 811. A press unit 860 is provided on a downstream side of the folding conveyance roller 811 in the conveyance direction of the sheet, and the sheet bundle is conveyed up to the press unit 860. The press unit 860 applies pressure to a folding portion, thereby folding the sheet bundle more reliably. The sheet bundle is folded by the press unit 860, then discharged toward a bookbinding tray 850 by the folding conveyance roller 811.

Here, the aforementioned bookbinding processing tray 580 sequentially stacks the sheets discharged from the image forming apparatus 10. As described above, since the sheets stacked on the bookbinding processing tray 580 are folded so that the middle part of the sheets stick out, the first stacked sheet will be on the inside when folded, and the last stacked sheet will be on the outside when folded. For this reason, in a case in which binding is performed, the sheet that is to become the cover needs to be on the outside. Therefore, the cover is the last to be imaged and the last to be stacked on the bookbinding processing tray 580.

### Overall System Block Diagram

Next, a control configuration of the entire image forming system 1 in this embodiment will be described. FIG. 2 is a block diagram showing the control configuration of the entire image forming system 1 in this embodiment.

An image forming system 1 includes a CPU circuit portion 900. The CPU circuit portion 900 incorporates the CPU 901 as a controller, and a ROM 902 and a RAM 903 as storage portions.

The CPU 901 performs basic control of the entire image forming system 1. The CPU 901 is connected to the ROM 902 in which a control program is written and the RAM 903 for performing processing via an address bus and a data bus. The CPU 901 performs overall control of each of controllers 911, 921, 904, 922, 931, 941, and 951, which will be described later, using a control program stored in the ROM 902. The RAM 903 temporarily holds a control data and is used as a work area for arithmetic processing associated with control. The CPU circuit portion 900 is provided in the image forming apparatus 10 (printer 350 in this embodiment).

A document feeding device controller 911 controls the driving of the document feeding device 100 and the like based on instructions from the CPU circuit portion 900. The document feeding device controller 911 is provided in the image forming apparatus 10 (document feeding device 100 in this embodiment). An image reader controller 921 controls the driving of the scanner unit 104, processing operations of the image sensor 109 and the like based on instructions from the CPU circuit portion 900. The image reader controller 921 then transfers an image signal output from the image sensor 109 to an image signal controller 922. The image reader controller 921 is provided in the image forming apparatus 10 (image reader 200 in this embodiment).

The image signal controller 922 converts the analog image signal from the image sensor 109 into a digital signal, then performs various processes on the digital signal. The image signal controller 922 then converts the processed digital signal into a video signal and outputs it to the printer controller 931. Further, the image signal controller 922 performs various processes on the digital image signal input from the computer 990 via an external I/F 904, converts the processed digital image signal into the video signal, and outputs it to the printer controller 931. The processing operations by the image signal controller 922 are controlled by the CPU circuit portion 900. The image signal controller 922 is provided in the image forming apparatus 10 (printer 350 in this embodiment). The printer controller 931 controls the exposure portion 110 and the printer 350 based on the input video signal to perform image formation and sheet conveyance. The processing operations of the printer controller 931 are controlled by the CPU circuit portion 900. The printer controller 931 is provided in the image forming apparatus 10 (printer 350 in this embodiment).

A finisher controller 951 exchanges information with the CPU circuit portion 900 to perform control of the entire finisher 500, such as driving the finisher 500. The finisher controller 951 is mounted on the finisher 500.

An operation display device controller 941 performs control of the exchange of information between the operation display device 600 and the CPU circuit portion 900. The operation display device 600 has a plurality of keys (input portions) for setting various functions related to image formation, a display unit for displaying information indicating the setting status, and the like. The operation display device controller 941 outputs a key signal corresponding to the operation of each key to the CPU circuit portion 900, and also displays corresponding information on the operation display device 600 based on the signal from the CPU circuit portion 900. The operation display device controller 941 is provided in the image forming apparatus 10 (operation display device 600 in this embodiment).

In this embodiment, the external I/F 904 and the operation display device controller 941 function respectively as acquiring portions that acquire information on the type of the recording material (sheet) on which the toner image is formed.

The CPU 901 of the CPU circuit portion 900 performs control so that the fixing temperature becomes the set temperature by controlling the power supply to the heater 403 based on the detection result of the temperature by the temperature detecting portion 404 of the fixing portion 117 via the printer controller 931. That is, in a case in which the detected temperature is lower than the set temperature, the CPU 901 outputs a control signal to turn on the heater 403. Further, if the detected temperature is higher than the set temperature, the CPU 901 outputs a control signal to turn off the heater 403.

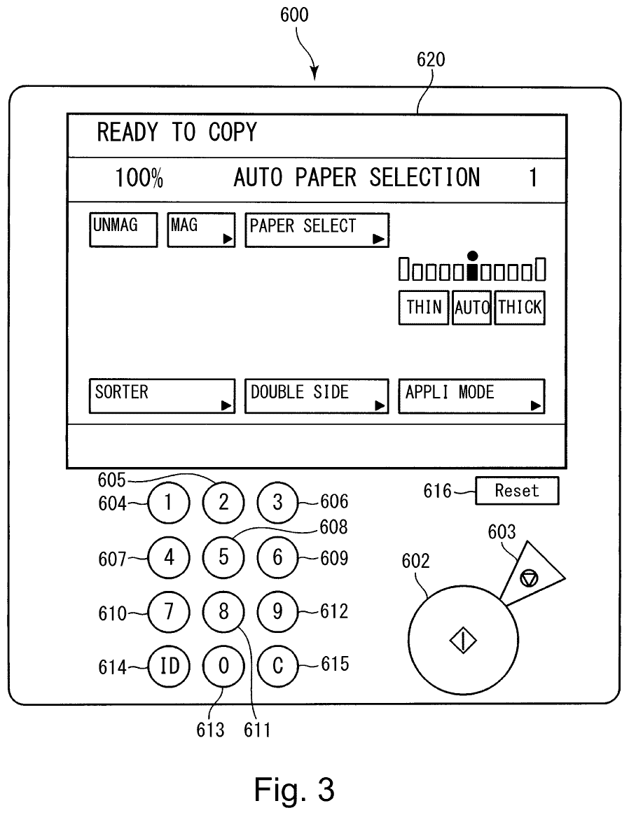

Next, the operation display device (operating portion) 600 will be described. FIG. 3 is a schematic view of the operation display device 600 in this embodiment. The operation display device 600 includes a touch panel 620, numeric keys 604 to 613, an ID key 614, a clear key 615, a reset button 616, a start button 602, and a stop button 603.

The touch panel 620 has a liquid crystal display screen and a detection portion that can acquire the XY coordinates on the liquid crystal display screen pressed (operated) by the user. The numeric keys 604 to 613 are used to input numerical values such as the number of copies of a job and the magnification. The ID key 614 is used to input the management number of the user who uses the image forming system 1. The clear key 615 is for clearing the values input from the numeric keys 604 to 613.

The reset button 616 is used to return job settings input from the touch panel 620 to their initial values. The start button 602 is used to start a job based on job settings input from the touch panel 620. The stop button 603 is used to stop the job started by the start button 602.

Incidentally, a job (print job) is a series of operations started by a single start instruction to form and output an image on one or a plurality of sheets.

### Issues

Next, the aforementioned issues will be explained in further detail.

In order to fix an unfixed toner image on the sheet to the sheet, a heat amount that takes into consideration the heat amount absorbed by the sheet is required. Therefore, it is desirable to change the temperature of the fixing portion (fixing temperature) in accordance with the sheet type. Further, in a case in which printing is continuously performed on different sheet types, a waiting time to change the fixing temperature (extend the paper interval) may be necessary when switching the sheet type.

In the method described in the aforementioned Japanese Laid-Open Patent Application (JP-A) Publication No. 2023-105654, even in a case in which an optimal target temperature table is selected, the fixing temperature for each sheet type classified by basis weight or paper type category (coated paper, fine paper, and the like) is a single fixed value, as shown in FIG. 18 of the present application.

Here, looking at the fixing temperatures selected in each of the thick paper mode, thin paper mode, and balance mode, for example, it can be seen that the fixing temperature for fine paper with a basis weight of 129 to 150 g/m² has a range of 165° C. to 170° C. ((1) in FIG. 18). That is, it can be said that the fixing temperature does not have a single fixed value depending on the sheet type, but has a allowable temperature range.

Incidentally, regarding the numerical range, “to” means that the numerical values before and after it are included.

However, in the method described in Japanese Laid-Open Patent Application (JP-A) Publication No. 2023-105654, the fixing temperature is set at a single fixed value depending on the selected mode. Therefore, for example, in a case in which fine paper with a basis weight of 129 to 150 g/m² ((1) in FIG. 18) is mixed with fine paper with a basis weight of 257 to 300 g/m² ((2) in FIG. 18), there is a difference in the fixing temperature regardless of which mode is selected, causing the occurrence of the waiting time due to the temperature switching operation.

In contrast, as described above, the fixing temperature does not have a single fixed value, but has an allowable temperature range depending on the sheet type. Therefore, for fine paper with a basis weight of 129 to 150 g/m², a fixing temperature range of 170° C. (lower limit value) to 177° C. (upper limit value) is allowed. Further, for fine paper with a basis weight of 257 to 300 g/m², a fixing temperature range of 175° C. (lower limit value) to 184° C. (upper limit value) is allowed. In this case, if the fixing temperature is set within the range of 175° C. to 177° C., the temperature switching operation will not occur.

Thus, in the method described in Japanese Laid-Open Patent Application (JP-A) Publication No. 2023-105654, the fixing temperature is limited to a single fixed value depending on the mode within the range of allowable fixing temperatures (target temperatures) (hereinafter also referred to as “fixing temperature range”) for each sheet type. Therefore, even if there is an overlapped range where the fixing temperature range for a first sheet type and the fixing temperature range for a subsequent second sheet type overlap each other, there may be a case in which a difference in fixing temperature is determined and the temperature switching operation occurs. The number of combination patterns of sheet types that are different between pages is enormous, and in the method of selecting a target temperature table described in Japanese Laid-Open Patent Application (JP-A) Publication No. 2023-105654, the number of target temperature tables that can be held is limited, so the effect of suppressing the occurrence of the waiting time caused by the temperature switching operation is limited. That is, conventionally, there is the issue that the allowable fixing temperature range for each sheet type has not been utilized to the fullest extent.

### Summary of Solutions

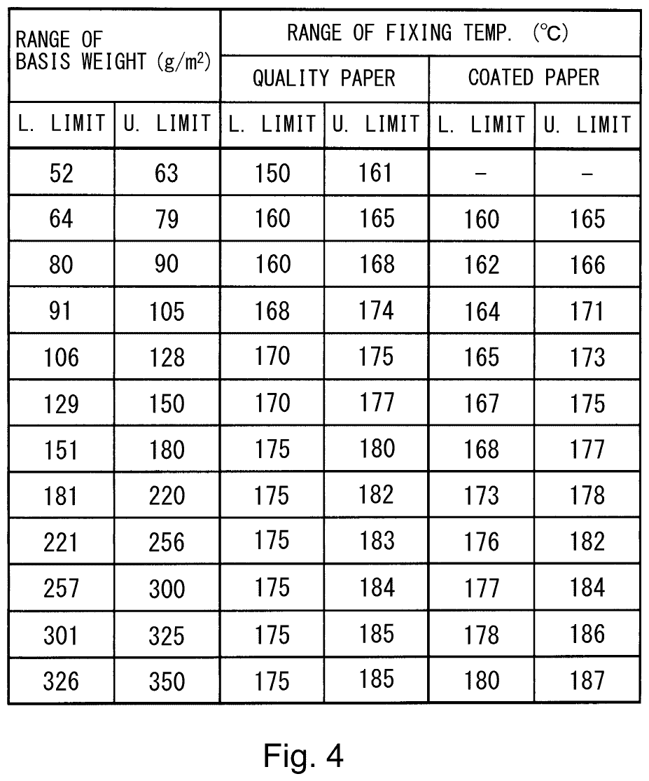

Therefore, in this embodiment, the allowable fixing temperature range for each sheet type is defined by the lower limit value and the upper limit value in the form of a table and the like, such as that shown in FIG. 4. Further, information on the sheet type for a predetermined number of pages (hereinafter also referred to as “sheet type information”) is acquired prior to image formation on the sheet, and a determination is performed based on the acquired sheet type information to check whether different sheet types are mixed. Further, a determination is performed to check whether there is an overlap in the allowable fixing temperature range for the mixed sheet types. Further, as a result of the determination, if there is an overlap, a fixing temperature is selected from the overlapped fixing temperature range, and if there is not an overlap, a fixing temperature that minimizes the difference between the fixing temperatures is selected.

This suppresses the occurrence of the waiting time caused by the temperature switching operation when executing a job in which different sheets types are mixed, thereby improving productivity. Incidentally, productivity is the number of pages output per unit time, and when the number of pages output per unit time is large, productivity is high, and when the number of pages output per unit time is small, productivity is low.

### Outline of Prefetching Fixing Control

Next, an outline of a prefetching fixing control in this embodiment will be described. The prefetching fixing control in this embodiment is a control in which page information on the predetermined number of pages is received prior to image formation of those pages, and the fixing temperature is set using the target temperature table in FIG. 4 based on the sheet type information contained in the received page information. The timing for acquiring the page information on the predetermined number of pages is the timing before the sheet for the first page of the predetermined number of pages reaches the fixing portion 117 after the start of the image forming operation. Typically, the timing for acquiring the page information on the predetermined number of pages is the timing before image formation (exposure process) for the first page of the predetermined number of pages is started. Further, the page information on the predetermined number of pages including the first page of the job is acquired at the start of the job, before the image forming operation is started. Here, the predetermined number of pages can be determined appropriately based on a configuration of the printer 350 or the usage status of the image forming apparatus 10 in the market. In this embodiment, the predetermined number of pages is set to 10 pages. Further, the page information may include various information relating to settings of the image forming operation (for example, information specifying one-sided printing or double-sided printing) in addition to the sheet type information. In this embodiment, the CPU 901 performs the prefetching fixing control. Further, in this embodiment, the

In the target temperature table in FIG. 4, the lower limit value and the upper limit value of the fixing temperature are set for each sheet type. In this embodiment, for each paper type category (fine paper, coated paper, and the like), the lower limit value and the upper limit value of the fixing temperature are set for each predetermined basis weight range. For example, for fine paper with a basis weight of 80 to 90 g/m², the CPU 901 uses the target temperature table in FIG. 4 to determine the fixing temperature to be set in the fixing portion 117 from the fixing temperature range of 160° C. (lower limit value) to 168° C. (upper limit value).

### Specific Example of Prefetching Fixing Control

A specific example of a method for determining the fixing temperature from the fixing temperature range will be described below.

### Pattern With Same Sheet Type

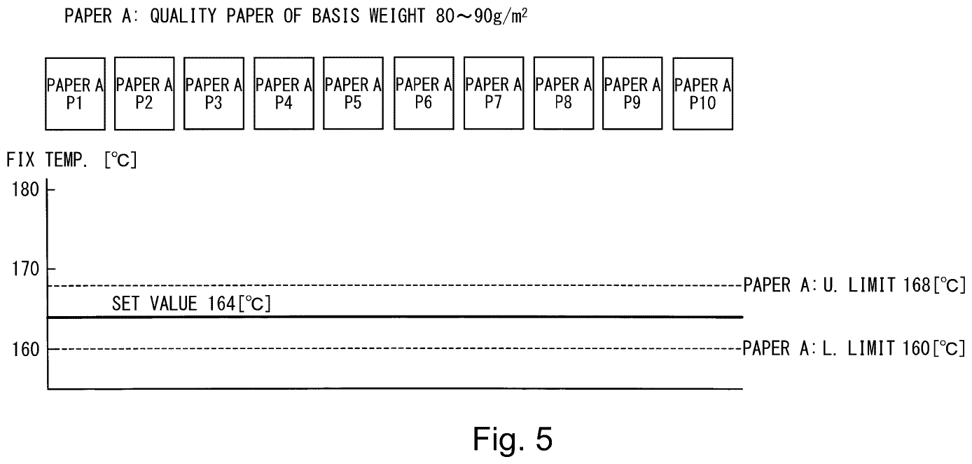

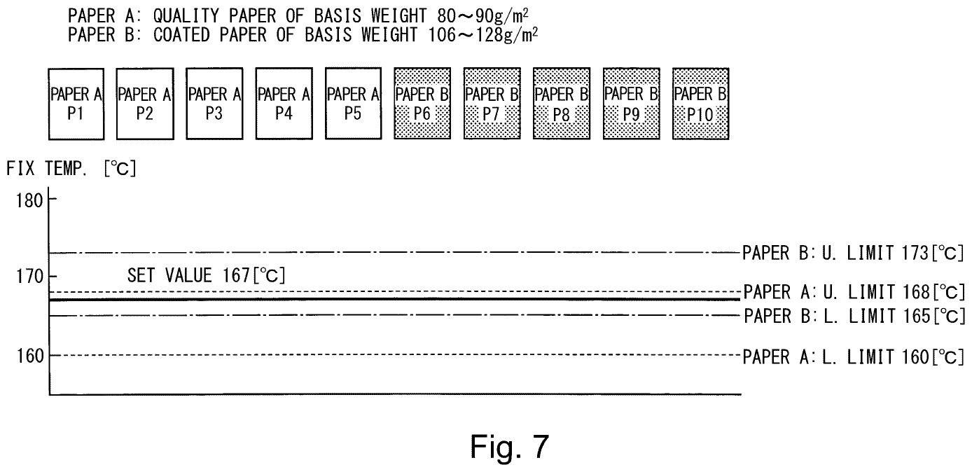

First, a case in which the sheet type is the same will be described with reference to FIG. 5. As a specific example, a case in which 10 pages using a sheet type A (fine paper with a basis weight of 80 to 90 g/m²) are printed will be explained. FIG. 5 is an explanatory diagram for explaining the setting of the fixing temperature for each page, with the top row showing a schematic view showing the sheet type for each page (“P1, P2 . . . ” indicates “first page, second page . . . ”), and the bottom row showing a graph showing the fixing temperature for each page. Incidentally, FIGS. 7, 8, and 9 are similar explanatory diagrams showing cases different from FIG. 5.

All of the sheet type information included in the page information on 10 pages received by the CPU 901 prior to image formation is the sheet type A. From the target temperature table in FIG. 4, the lower limit value of the fixing temperature range for the sheet type A is 160° C., and the upper limit value is 168° C. In this case, the CPU 901 determines the fixing temperature to be 164° C., which is the central value (median value) between the lower limit value and the upper limit value in the fixing temperature range of 160° C. to 168° C. Incidentally, if the difference between the upper limit value and the lower limit value is an odd number, digits after the decimal point are rounded up.

### Pattern With Different Sheet Types

### Pattern Description

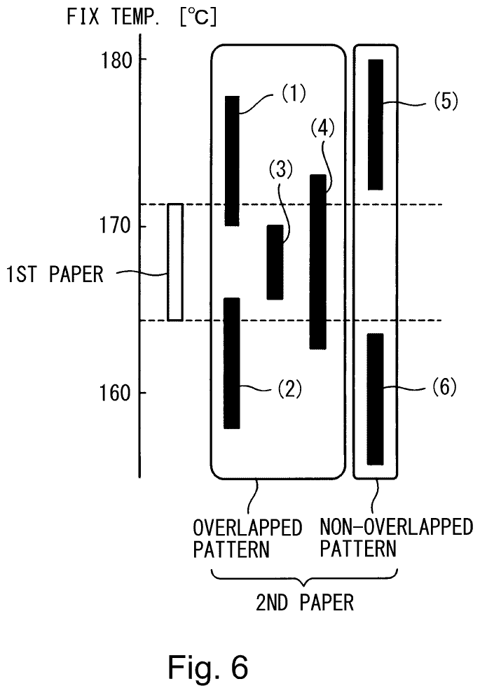

Next, a case in which the sheet types are different will be described. FIG. 6 is a schematic view showing the relationship between the fixing temperature range for the first sheet type and the subsequent second sheet type that is different from that for the first sheet type. The first sheet type is the sheet type of the first page, and the second sheet type is the sheet type of the subsequent second page. The first page can be said to be a target page for determining the fixing temperature. As shown in FIG. 6, in a case in which the sheet types of the first sheet type and the second sheet type are different, there are broadly two patterns: a pattern in which there is the overlapped range where the fixing temperature range for the first sheet type and the fixing temperature range for the second sheet type overlap each other (“pattern with the overlapped fixing temperature range”), and a pattern in which there is not the overlapped range (“pattern with the non-overlapped fixing temperature range”).

Further, the pattern with the overlapped fixing temperature range includes patterns (1) to (4). The pattern (1) is a pattern in which part of the fixing temperature range for the second sheet type is higher than the fixing temperature range for the first sheet type (the lower limit value of the second sheet type is lower than the upper limit value of the first sheet type, and the upper limit value of the second sheet type is higher than the upper limit value of the first sheet type). The pattern (2) is a pattern in which part of the fixing temperature range for the second sheet type is lower than the fixing temperature range for the first sheet type (the upper limit value of the second sheet type is higher than the lower limit value of the first sheet type, and the lower limit value of the second sheet type is lower than the lower limit value of the first sheet type). The pattern (3) is a pattern in which the fixing temperature range for the second sheet type is narrower than the fixing temperature range for the first sheet type (the upper limit value of the second sheet type is lower than the upper limit value of the first sheet type, and the lower limit value of the second sheet type is higher than the lower limit value of the first sheet type). The pattern (4) is a pattern in which the fixing temperature range for the second sheet type is wider than the fixing temperature range for the first sheet type (the upper limit value of the second sheet type is higher than the upper limit value of the first sheet type, and the lower limit value of the second sheet type is lower than the lower limit value of the first sheet type).

Further, the pattern with the non-overlapped fixing temperature range includes patterns (5) and (6). The pattern (5) is a pattern in which the fixing temperature range for the second sheet type is higher than the fixing temperature range for the first sheet type (the lower limit value of the second sheet type is higher than the upper limit value of the first sheet type). The pattern (6) is a pattern in which the fixing temperature range for the second sheet type is lower than the fixing temperature range for the first sheet type (the upper limit value of the second sheet type is lower than the lower limit value of the first sheet type).

Incidentally, there is also a pattern with the same fixing temperature range even if the sheet types are different. In this case, the determination method for the fixing temperature is to determine the fixing temperature in the same way as for the pattern with the overlapped fixing temperature range or the aforementioned pattern with the same sheet type.

### Pattern with Different Sheet Types and Overlapped Fixing Temperature Range

First, the pattern (1) in FIG. 6, which is an example of a pattern with the overlapped fixing temperature range, will be described with reference to FIG. 7. As a specific example, a case in which 5 pages using the sheet type A (fine paper with a basis weight of 80 to 90 g/m²) are printed, then 5 pages using a sheet type B (coated paper with a basis weight of 106 to 128 g/m²) are printed will be explained.

The sheet type information included in the page information on 10 pages received by the CPU 901 prior to image formation is the sheet types A and B. From the target temperature table in FIG. 4, the lower limit value of the fixing temperature range for the sheet type A is 160° C., and the upper limit value is 168° C. Further, the lower limit value of the fixing temperature range for the sheet type B is 165° C., and the upper limit value is 173° C. The overlapped fixing temperature range for the sheet types A and B is 165° C. to 168° C. In this case, the CPU 901 determines the fixing temperature to be 167° C., which is the central value of the overlapped fixing temperature range of 165° C. to 168° C., with digits after the decimal point rounded up.

### Pattern With Different Sheet Types and Non-Overlapped Fixing Temperature Range

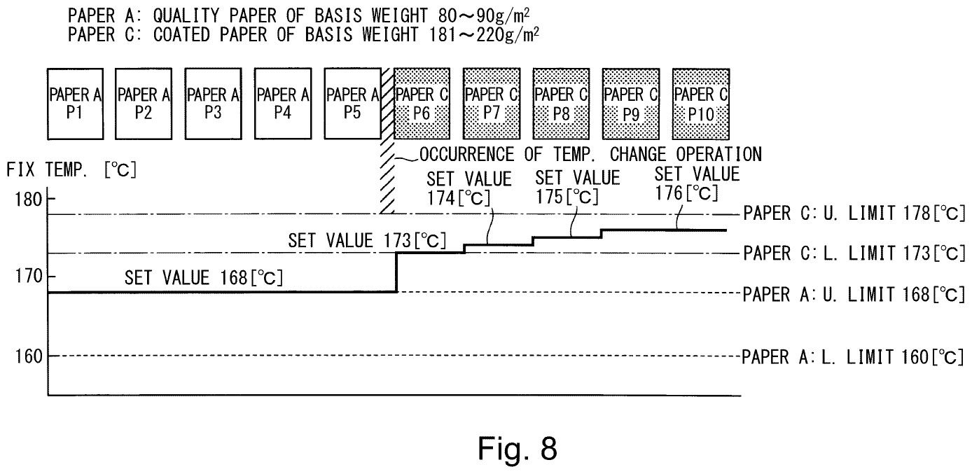

Next, the pattern (5) in FIG. 6, which is an example of a pattern with the non-overlapped fixing temperature range, will be described with reference to FIG. 8. As a specific example, a case in which 5 pages using the sheet type A (fine paper with a basis weight of 80 to 90 g/m²) are printed, then 5 pages using a sheet type C (coated paper with a basis weight of 181 to 220 g/m²) are printed will be explained.

The sheet type information included in the page information on 10 pages received by the CPU 901 prior to image formation is the sheet types A and C. From the target temperature table in FIG. 4, the lower limit value of the fixing temperature range for the sheet type A is 160° C., and the upper limit value is 168° C. Further, the lower limit value of the fixing temperature range for the sheet type C is 173° C., and the upper limit value is 178° C. Since there is not the overlapped fixing temperature range for the sheet types A and C, the temperature switching operation is performed in this case. In this case, the CPU 901 determines the fixing temperature for the sheet type A to be 168° C., which is the upper limit value of the fixing temperature range for the sheet type A, and determines the fixing temperature for the sheet type C to be 173° C., which is the lower limit value of the fixing temperature range for the sheet type C.

As a result, even if the temperature switching operation is performed and the waiting time occurs, the fixing temperature is set at a fixing temperature that minimizes the difference between the changed fixing temperatures, so the waiting time can be shortened. Incidentally, this waiting time is the time during which processing is performed to wait for the image forming operation until the fixing temperature reaches the set fixing temperature (until the change in the fixing temperature is completed).

For the sheet type C for pages P7 and onward, the fixing temperature is increased stepwise by increments of 1° C. for each page until it reaches 176° C., which is the central value between the lower limit value and the upper limit value of the fixing temperature range for the sheet type C. A temperature change upper limit in a case in which the fixing temperature is changed between pages of the same sheet type will be explained later.

### Pattern for Outputting More Than 10 Pages

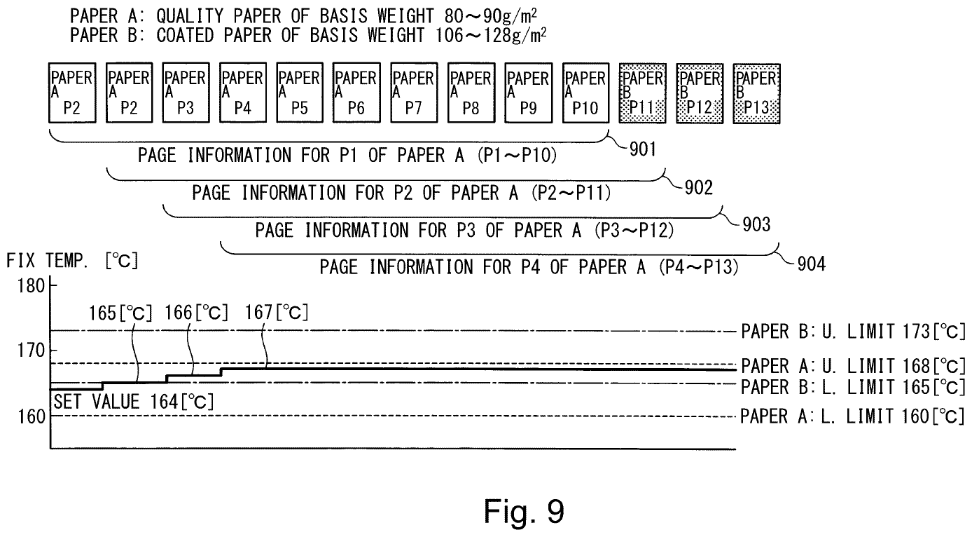

Next, a method for determining the fixing temperature when outputting more than 10 pages, and the temperature change upper limit when changing the fixing temperature between pages of the same sheet type will be described with reference to FIG. 9. As a specific example, a case in which 10 pages using the sheet type A (fine paper with a basis weight of 80 to 90 g/m²) are printed, then the sheet type is switched to the sheet type B (coated paper with a basis weight of 106 to 128 g/m²) and printing is continued will be described.

The fixing temperature for the first page of the sheet type A is determined as follows based on page information 901 for 10 pages (pages P1 to P10) received prior to image formation of the first page. That is, all of the sheet type information included in the page information 901 for 10 pages (pages P1 to P10) received by the CPU 901 prior to image formation of the first page of the sheet type A is the sheet type A. Therefore, as described with reference to FIG. 5, the CPU 901 determines 164° C., which is the central value of the fixing temperature range of 160° C. to 168° C. for the sheet type A, to be the fixing temperature for the first page.

The fixing temperature for the second page of the sheet type A is determined as follows based on page information 902 for 10 pages (pages P2 to P11) received prior to image formation of the second page. That is, the sheet type information included in the page information 902 for 10 pages (pages P2 to P11) received by the CPU 901 prior to image formation of the second page of the sheet type A includes the sheet type B (page P11) which is different from the sheet type A. Therefore, as described with reference to FIG. 7, the CPU 901 determines 167° C. to be the fixing temperature for the second page based on the overlapped fixing temperature range for the the sheet types A and B.

Here, the temperature change upper limit of the fixing temperature will be described. The temperature change upper limit can be said to be the upper limit value of the change width of the fixing temperature that can be made at one time after image formation for the job has started.

In this case, the fixing temperature for the first page of the sheet type A is determined to be 164° C., and the fixing temperature for the second page is determined to be 167° C., resulting in a difference of 3° C. between the two fixing temperatures. The fixing temperature for the first page and the fixing temperature for the second page are both included in the fixing temperature range for the sheet type A, so there is no need to perform the temperature switching operation which would cause the waiting time. However, in this case, at the timing when the sheet of the first page leaves the fixing portion 117, the fixing temperature must be changed to 167° C., which is the fixing temperature for the second page. However, if the setting of the fixing temperature is changed by 3° C. at once, the fixing temperature will change while the sheet of the second page is passing through the fixing portion 117. Therefore, there is a possibility that the glossiness of the fixed image will change midway through the sheet, which may affect the image on the second page.

Therefore, in this embodiment, when the fixing temperature is changed without performing the temperature switching operation (without extending the paper interval and causing the waiting time), the temperature change upper limit is set so as not to affect the image after fixing. In this embodiment, a change upper limit temperature is set at 1° C. Therefore, the fixing temperature (target temperature) of the second page is determined to be 167° C., but the fixing temperature (set temperature) actually set in the fixing portion 117 is 165° C. Incidentally, the change upper limit temperature is not limited to 1° C. as long as it is a temperature that can sufficiently suppress any effect on the image. The change upper limit temperature can be said to be the upper limit of the change width of the fixing temperature (which can be changed in the paper interval without extending the paper interval), which does not require the temperature switching operation which causes the waiting time to be performed.

The fixing temperature for the third page of the sheet type A is determined by the same process as the second page of the sheet type A, based on page information 903 for 10 pages (pages P3 to P12) received prior to image formation of the third page. Further, the fixing temperature for the fourth page of the sheet type A is determined by the same process as the second page of the sheet type A, based on page information 904 for 10 pages (pages P4 to P13) received prior to the image formation of the fourth page. <Flow of prefetching fixing control>

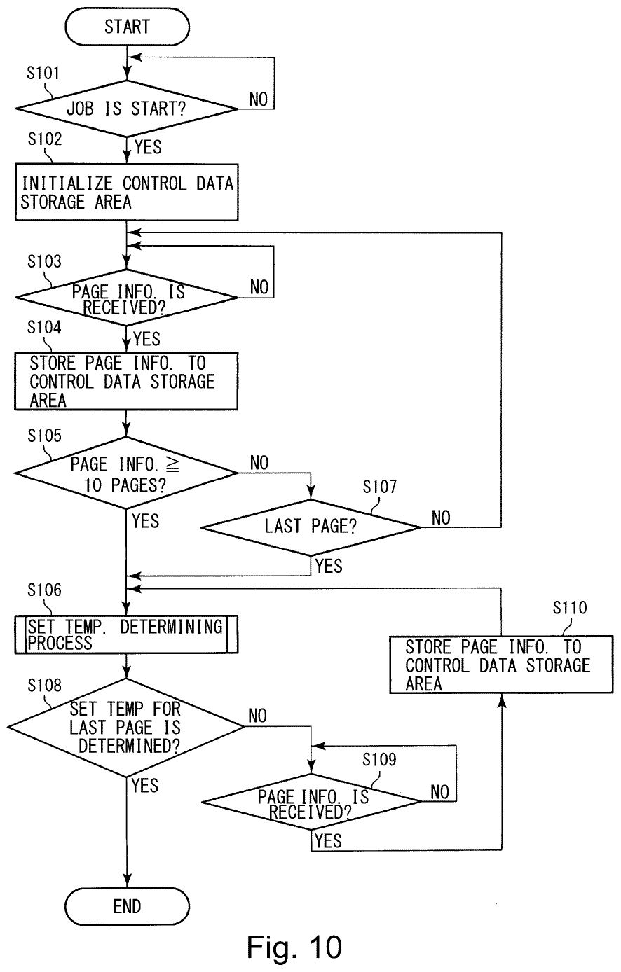

Next, the procedure for the prefetching fixing control will be described with reference to flow chart diagrams in FIGS. 10, 11, and 12. {Overall flow}

First, an overall flow of the prefetching fixing control will be described with reference to FIG. 10. The processes shown in FIG. 10 are performed by the CPU 901. In the flow chart diagrams, symbols denoted with “S” are step numbers for specifying the process.

In S101, the CPU 901 waits for a start key 602 to be pressed, and if it is pressed, the CPU 901 starts the job, then proceeds to S102.

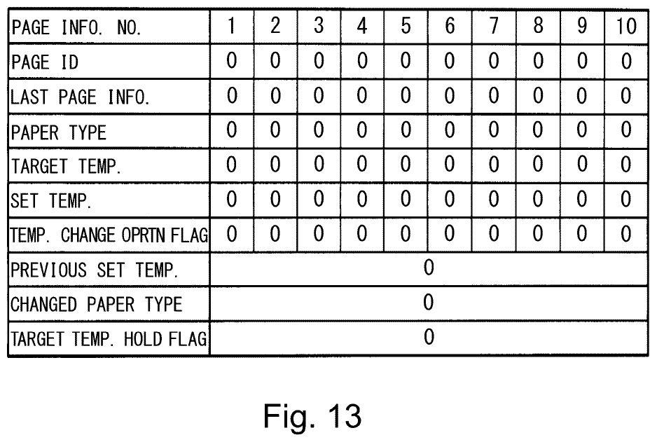

In S102, the CPU 901 initializes the storage area in the control data shown in FIG. 13 in the RAM 903, then proceeds to S103. The control data shown in FIG. 13 has a storage area for storing a total of six types of information on 10 pages: a “page ID” assigned to each page for page identification, “last page information” indicating the last page of the job, “sheet type information” such as the aforementioned sheet types A and B, “target temperature information” determined on a page-by-page basis, “set temperature information” that is ultimately set, and a “temperature switching operation flag” indicating whether the page requires the temperature switching operation. Further, this control data has a storage area for storing three types of information: “previously set temperature information” that stores the previously set temperature, “changed sheet type information” that stores that the sheet type has been switched, and a “target temperature maintenance flag” that indicates the state in which the target temperature is maintained without being changed.

In S103, the CPU 901 waits for the page information to be received, and if it is received, proceeds to S104.

In S104, the CPU 901 stores information necessary for the control data acquired from the received page information in the control data storage area, then proceeds to S105.

In S105, the CPU 901 determines whether or not a reception of the page information on 10 pages has been completed; if the reception has been completed, the CPU 901 proceeds to S106, and if the reception has not been completed, the CPU 901 proceeds to S107.

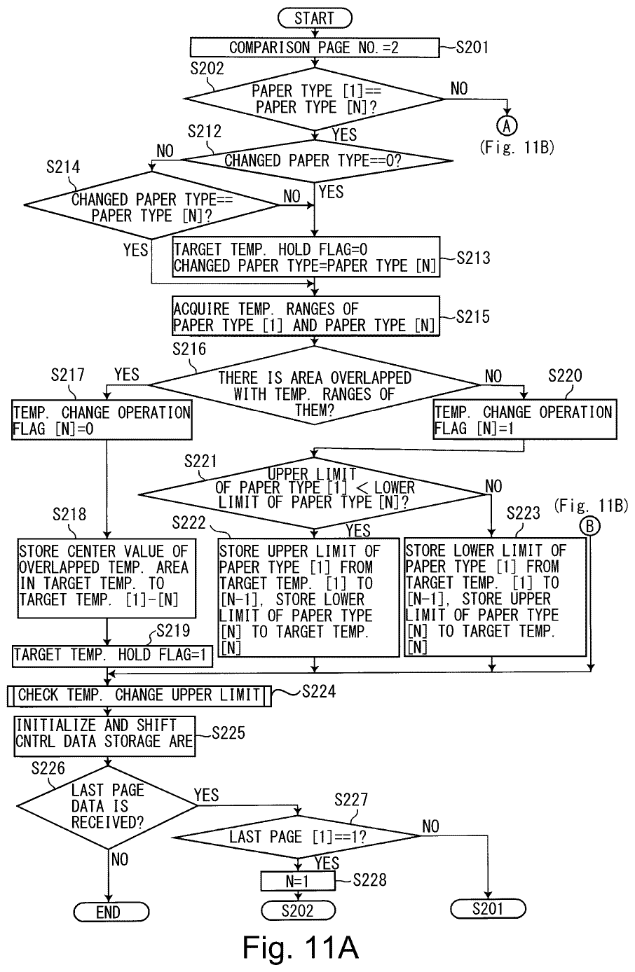

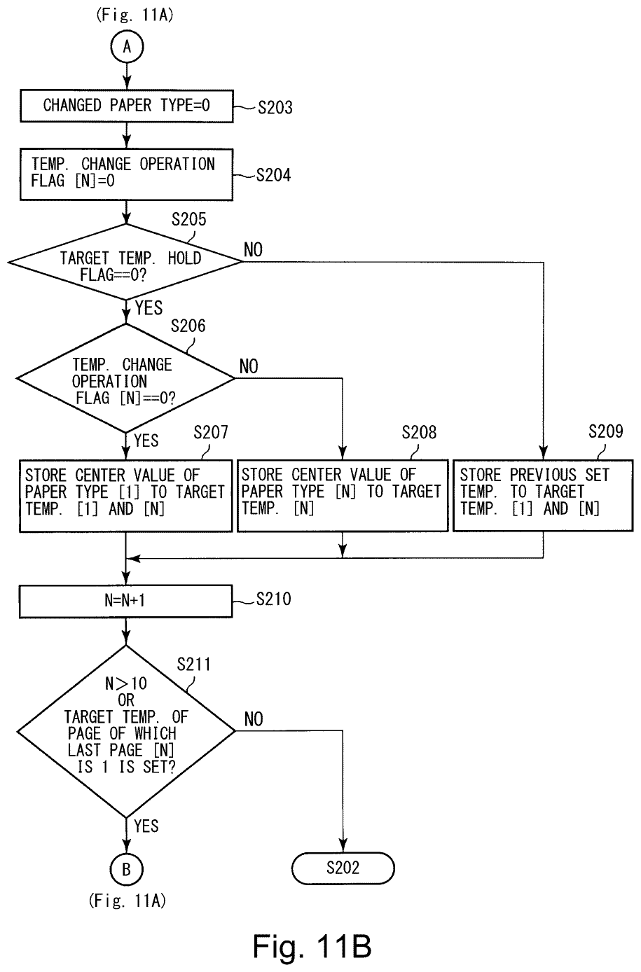

In S106, if the reception of the page information on 10 pages has been completed in S105, or if reception of the last page has been completed in S107 (described later), the CPU 901 executes the set temperature determining process. When the set temperature determining process is completed, the set temperature of the page is determined. The set temperature determining process will be described later with reference to FIG. 11.

In S107, the CPU 901 determines whether or not the reception of the last page has been completed; if it has been completed, the CPU 901 proceeds to S106, and if it has not been completed, the CPU 901 proceeds to S103.

In S108, the CPU 901 determines whether or not the set temperature for the last page has been determined; if it has been determined, the flow of the prefetching fixing control ends, and if it has not been determined, the CPU 901 proceeds to S109.

In S109, the CPU 901 waits for the page information to be newly received, and if it is received, the CPU 901 proceeds to S110.

In S110, the CPU 901 stores information necessary for the control data acquired from the received page information in the control data storage area, then proceeds to S106.

### Flow of Set Temperature Determining Process

Next, the set temperature determining process will be described with reference to FIG. 11. The processes shown in FIG. 11 are performed by the CPU 901. Incidentally, for convenience, the flow chart diagram in FIG. 11 is divided into FIGS. 11A and 11B.

### Pattern With Same Sheet Type

First, the flow of the set temperature determining process when the same sheet type is used and the temperature switching operation is not required will be described using the job described with reference to FIG. 5.

In S201, the CPU 901 initializes a page information number N to be compared against the data of a page information number 1 in the control data to 2, then proceeds to S202. Incidentally, the data for the page information number 1 is described as “information name [1]” and the data for the page information number N is described as “information name [N]”.

In S202, the CPU 901 compares sheet type information [1] (page P1 in the example in FIG. 5) with sheet type information [N] (pages P2 to P10 in the example in FIG. 5) in the control data; if the sheet types are different, the CPU 901 proceeds to S212, and if the sheet type is the same, the CPU 901 proceeds to S203.

S203 to S211 are the flow for determining the target temperature when all of the sheet type information in the control data is the same sheet type, and S212 to S223 are the flow for determining the target temperature when there are different sheets types in the sheet type information in the control data.

In S203, the CPU 901 initializes the changed sheet type information in the control data to 0, then proceeds to S204.

In S204, the CPU 901 initializes temperature switching operation flag information [N] in the control data to 0, then proceeds to S205.

In S205, the CPU 901 determines whether or not target temperature maintenance flag information in the control data is 0; if it is 0, the CPU 901 proceeds to S206, and if it is not 0, the CPU 901 proceeds to S209. The target temperature maintenance flag information is set in S219, which will be described later, and is information for determining whether or not to maintain the target temperature without changing it in the pattern with the overlapped fixing temperature range, which has been described with reference to FIG. 7. In the example in FIG. 5, as a result of the determination in S202, the process does not proceed to S212, so S219 is not executed. Therefore, the target temperature maintenance flag information is 0, so the process proceeds to S206.

In S206, the CPU 901 determines whether or not temperature switching operation flag information [1] in the control data is 0; if it is 0, the CPU 901 proceeds to S207, and if it is not 0, the CPU 901 proceeds to S208. The temperature switching operation flag information is set in S220, which will be described later, and the temperature switching operation is performed on the page for which the temperature switching operation flag information is set to 1. That is, the temperature switching operation is performed before forming an image on a page for which the temperature switching operation flag information is set to 1. In the example in FIG. 5, as a result of the determination in S202, the process does not proceed to S212, so S220 is not executed. Therefore, the temperature switching operation flag information is 0, so the process proceeds to S207.

In S207, the CPU 901 stores the central value between the lower limit value and the upper limit value of the fixing temperature range for the sheet type in the sheet type information [1] in target temperature information [1] and target temperature information [N] in the control data, then proceeds to S210. In the example in FIG. 5, the central value is 164° C.

In S210, the CPU 901 adds 1 to the page information number N, then proceeds to S211.

In S211, the CPU 901 determines whether or not one of the following conditions is met: the page information number N exceeds 10 pages, or the target temperature setting for the page for which a last page information [N] is 1 has already been executed. Further, if one of the conditions is met, the CPU 901 proceeds to S224, and if neither condition is met, the CPU 901 proceeds to S202.

In S224, the CPU 901 executes a temperature change upper limit checking process, determines the set temperature for the page with page ID information [1], then proceeds to S225. The temperature change upper limit checking process will be described later with reference to FIG. 13.

In the example in FIG. 5, when the process proceeds to S224, S207 is executed for all of the pages P1 to P10, so the same target temperature (164° C.) is set in target temperature information [1] to [10] (part (a) of FIG. 15).

In S225, the CPU 901 overwrites and updates the data in the storage area of the page information number 1 in the control data with the data in the storage area of a page information number 2. Similarly, the CPU 901 overwrites and updates the data in the storage areas of page information numbers 2 to 9 with the data in the storage areas of page information numbers 3 to 10, respectively. Further, the CPU 901 initializes the entire storage area for the page information number 10 to 0. As a result, in the example in FIG. 5, the information on the page P1 (sheet type A) is erased from the storage area in the control data (part (b) of FIG. 15). Thereafter, the CPU 901 proceeds to S226.

In S226, the CPU 901 determines whether or not there is a page for which the last page information is set in the control data. Further, if there is a page for which the last page information is set, the CPU 901 proceeds to S227, and if there is no page for which the last page information is set, the CPU 901 ends the flow of the set temperature determining process. In the example in FIG. 5, the page P10 is the last page information, so the process proceeds to S227 until there is no data left for the page P10 in the storage area in the control data (part (c) of FIG. 15).

In S227, the CPU 901 determines whether or not a last page information [1] is 1; if it is not 1, the CPU 901 proceeds to S201, and if it is 1, the CPU 901 proceeds to S228. In the example in FIG. 5, the process proceeds to S201 for the pages P2 to P9, and proceeds to S228 for the page P10.

In S228, the CPU 901 sets the page information number N to be compared against the data of the page information number 1 in the control data to 1, then proceeds to S202.

In the example in FIG. 5, the steps described above are repeated until there is no data left in the storage area in the control data, so that ultimately the same target temperature (164° C.) is set for the pages P1 to P10.

### Pattern With Different Sheet Types and Overlapped Fixing Temperature Range

Next, the flow of the set temperature determining process in a case in which the temperature switching operation is not performed will be described using the job described with reference to FIG. 7 as an example of the pattern with different sheet types and the overlapped fixing temperature range. For the pages P1 to P5 in FIG. 7, the processes in S201 to S211 are repeated in the same manner as for the pattern with the same sheet type described above. For the pages P6 to P10, if the sheet types A and B are stored in the sheet type information in the control data, control is executed in S202 so that the process proceeds to S212. Further, if only the sheet type B is stored in the sheet type information in the control data, control is executed in S202 so that the process proceeds to S203.

In S212, the CPU 901 determines whether or not the value is 0, which means that the data for the changed sheet type information is not stored; if the value is 0, the CPU 901 proceeds to S213, and if the value is not 0, the CPU 901 proceeds to S214. That is, in the example in FIG. 7, the process proceeds to S213 for the page P6, then proceeds to S214 for the pages P7 to P10.

In S213, the CPU 901 sets the target temperature maintenance flag to 0, stores the sheet type information [N] in the changed sheet type information, then proceeds to S215. In the example in FIG. 7, the sheet type B for the page P6 is set in the changed sheet type information.

In S214, the CPU 901 determines whether or not the changed sheet type information and the sheet type information [N] are the same; if they are the same, the process proceeds to S215, and if they are different, the process proceeds to S213. In the example in FIG. 7, for the pages P7 to P10, the changed sheet type information and the sheet type information [N] are the sheet type B, so the process proceeds to S215.

In S215, the CPU 901 acquires information on the fixing temperature range for the sheet type in the sheet type information [1] and for the sheet type in the sheet type information [N], then proceeds to S216.

In S216, the CPU 901 determines whether or not there is the overlapped fixing temperature range for the sheet type in the sheet type information [1] and for the sheet type in the sheet type information [N]; if there is the overlapped range, the CPU proceeds to S217, and if there is not the overlapped range, the CPU proceeds to S220. In the example in FIG. 7, there is the overlapped fixing temperature range, so the process proceeds to S217.

In S217, the CPU 901 sets the temperature switching operation flag information [N] to 0, then proceeds to S218.

In S218, the CPU 901 stores the central value of the overlapped fixing temperature range for the sheet type in the sheet type information [1] and for the sheet type in the sheet type information [N] in the target temperature information [1] to the target temperature information [N], then proceeds to S219.

In S219, the CPU 901 sets the target temperature maintenance flag information to 1, then proceeds to S224. In the example in FIG. 7, when the process proceeds to S224, the target temperature (167° C.) is set for the pages P1 to P6, and the target temperature maintenance flag information is set to 1.

In S224, the CPU 901 executes the temperature change upper limit checking process, determines the set temperature for the page with the page ID information [1], then proceeds to S225. The temperature change upper limit checking process will be described later with reference to FIG. 13. In the example in FIG. 7, the target temperature for the pages P1 to P5 (sheet type A) is ultimately set at 167° C., the target temperature for the page P6 (sheet type B) is set at 167° C., and the target temperature for the page P5 (167° C.) is stored as the previously set temperature (part (a) of FIG. 16).

In S225, the CPU 901 overwrites and updates the data in the storage area of the page information number 1 in the control data with the data in the storage area of the page information number 2. Similarly, the CPU 901 overwrites and updates the data in the storage areas of the page information numbers 2 to 9 with the data in the storage areas of the page information numbers 3 to 10, respectively. Further, the CPU 901 initializes the entire storage area for the page information number 10 to 0. As a result, in the example in FIG. 7, the information on the page P1 (sheet type A) is erased from the storage area in the control data (part (b) of FIG. 16). Thereafter, the CPU 901 proceeds to S226.

In S226, the CPU 901 determines whether or not there is a page for which the last page information is set in the control data. Further, if there is a page for which the last page information is set, the CPU 901 proceeds to S227, and if there is no page for which the last page information is set, the CPU 901 ends the flow of the set temperature determining process. In the example in FIG. 7, the page P10 is the last page information, so the process proceeds to S227 until there is no data left for the page P10 in the storage area in the control data.

In S227, the CPU 901 determines whether or not the last page information [1] is 1; if it is not 1, the process proceeds to S201, and if it is 1, the process proceeds to S228. In the example in FIG. 7, the process proceeds to S201 for the pages P2 to P9, and proceeds to S228 for the page P10.

In S228, the CPU 901 sets the page information number N to be compared against the data of the page information number 1 in the control data to 1, then proceeds to S202.

By repeating the above steps, the pages P1 to P5 (sheet type A) are removed from the storage area in the control data (part (c) of FIG. 16). Thereafter, for the pages P6 to P10 (sheet type B), the process in S202 proceeds to S203, then proceeds to the flow for determining the target temperature for when all of the pages are the same sheet type. Further, in the example in FIG. 7, since the target temperature maintenance flag information is set to 1 in S219, the process proceeds to S209 by the determination in S205.

In S209, the CPU 901 sets the previously set temperature (167° C.) to the target temperature information, then proceeds to S210.

In the example in FIG. 7, by executing S209 to S211 for the pages P6 to P10, the pages P6 to P10 are set at the same target temperature of 167° C. (part (d) of FIG. 16).

Thereafter, the same steps as for the pages P1 to P5 (sheet type A) are executed for the pages P6 to P10 (sheet type B), and S224 is executed, thereby setting the target temperature for the pages P6 to P10 (sheet type B) to 167° C.

In the example in FIG. 7, the steps described above are repeated until there is no data left in the storage area in the control data, and the same target temperature (167° C.) is ultimately set for the pages P1 to P10. (Pattern with different sheet types and non-overlapped fixing temperature range)

Next, the flow of the set temperature determining process in a case in which the temperature switching operation is performed will be described using the job described with reference to FIG. 8 as an example of the pattern with different sheet types and the non-overlapped fixing temperature range. For the pages P1 to P5 in FIG. 8, the processes in S201 to S211 are repeated in the same manner as for the pattern with the same sheet type described above. For the pages P6 to P10, if the sheet type information in the control data stores the sheet types A and C, control is executed in S202 to proceed to S212. Further, when only the sheet type C is stored in the sheet type information in the control data, control is executed in S202 to proceed to S203.

In S212, the CPU 901 determines whether or not the value is 0, which means that the data in the changed sheet type information is not stored; if the value is 0, the CPU 901 proceeds to S213, and if the value is not 0, the CPU 901 proceeds to S214. That is, in the example in FIG. 8, the process proceeds to S213 for the page P6, then proceeds to S214 for the pages P7 to P10.

In S213, the CPU 901 sets the target temperature maintenance flag to 0, stores the sheet type information [N] in the changed sheet type information, then proceeds to S215. In the example in FIG. 8, the sheet type C for the page P6 is set in the changed sheet type information.

In S214, the CPU 901 determines whether or not the changed sheet type information and the sheet type information [N] are the same; if they are the same, the process proceeds to S215, and if they are different, the process proceeds to S213. In the example in FIG. 8, for the pages P7 to P10, the changed sheet type information and the sheet type information [N] are both the sheet type C, so the process proceeds to S215.

In S215, the CPU 901 acquires the information on the fixing temperature range for the sheet type in the sheet type information [1] and the sheet type in the sheet type information [N], then proceeds to S216.

In S216, the CPU 901 determines whether or not there is the overlapped fixing temperature range for the sheet type in the sheet type information [1] and the sheet type in the sheet type information [N]; if there is the overlapped range, the CPU 901 proceeds to S217, and if there is not the overlapped range, the CPU 901 proceeds to S220. In the example in FIG. 8, there is not the overlapped fixing temperature range, so the process proceeds to S220.

In S220, the CPU 901 sets the temperature switching operation flag information [N] to 1, then proceeds to S221.

In S221, the CPU 901 compares the upper limit value of the fixing temperature range for the sheet type in the sheet type information [1] with the lower limit value of the fixing temperature range for the sheet type in the sheet type information [N]. Further, if the lower limit value of the fixing temperature range for the sheet type in the sheet type information [N] is greater than the upper limit value of the fixing temperature range for the sheet type in the sheet type information [1], the CPU 901 proceeds to S222; otherwise, the CPU 901 proceeds to S223.

In S222, the CPU 901 sets the upper limit value of the fixing temperature range for the sheet type in the sheet type information [1] to the target temperature information to target temperature information [N−1], sets the lower limit value of the fixing temperature range for the sheet type in the sheet type information [N] to the target temperature information [N], then proceeds to S224. The case in which S222 is executed corresponds to the case of the pattern (5) in FIG. 6 described above. In the example in FIG. 8, the target temperature for the pages P1 to P5 (sheet type A) is set at 168° C., which is the upper limit value of the fixing temperature range for the sheet type A, and the target temperature for the page P6 (sheet type C) is set at 173° C., which is the lower limit value of the fixing temperature range for the sheet type C.

In S223, the CPU 901 sets the lower limit value of the fixing temperature range for the sheet type in the sheet type information [1] to the target temperature information to the target temperature information [N−1], sets the upper limit value of the fixing temperature range for the sheet type in the sheet type information [N] to the target temperature information [N], then proceeds to S224. The case in which S223 is executed corresponds to the case of the pattern (6) in FIG. 6 described above.

In S222 and S223, if the temperature switching operation is performed, a target temperature is set with the smallest the temperature difference between the temperatures before and after the switching.

In the example in FIG. 8, when the process proceeds to S224, the target temperature for the pages P1 to P5 (sheet type A) is set at 168° C., and the target temperature for the page P6 (sheet type C) is set at 173° C.

In S224, the CPU 901 performs the temperature change upper limit checking process, determines the set temperature for the page in the page ID information [1], then proceeds to S225. The temperature change upper limit checking process will be described later with reference to FIG. 13. In the example in FIG. 8, the target temperature for the pages P1 to P5 (sheet type A) is ultimately set at 168° C., the target temperature for the page P6 (sheet type C) is set at 173° C., and the target temperature for the page P5 (168° C.) is stored as the previously set temperature (part (a) of FIG. 17).

In S225, the CPU 901 overwrites and updates the data in the storage area of the page information number 1 in the control data with the data in the storage area of the page information number 2. Similarly, the CPU 901 overwrites and updates the data in the storage areas of the page information numbers 2 to 9 with the data in the storage areas of the page information numbers 3 to 10, respectively. Further, the CPU 901 initializes the entire storage area for the page information number 10 to 0. As a result, in the example in FIG. 8, the information on the page P1 (sheet type A) is erased from the storage area in the control data (part (b) of FIG. 17). Thereafter, the CPU 901 proceeds to S226.

In S226, the CPU 901 determines whether or not there is a page for which the last page information is set in the control data. Further, if there is a page for which the last page information is set, the CPU 901 proceeds to S227, and if there is no page for which the last page information is set, the CPU 901 ends the flow of the set temperature determining process. In the example in FIG. 8, the page P10 is the last page information, so the process proceeds to S227 until there is no data left for the page P10 in the storage area in the control data.

In S227, the CPU 901 determines whether or not the last page information [1] is 1; if it is not 1, the CPU 901 proceeds to S201, and if it is 1, the CPU 901 proceeds to S228. In the example in FIG. 8, the process proceeds to S201 for the pages P2 to P9, and proceeds to S228 for the page P10.

In S228, the CPU 901 sets the page information number N to be compared against the data of the page information number 1 in the control data to 1, then proceeds to S202.

By repeating the above steps, the pages P1 to P5 (sheet type A) are removed from the storage area in the control data (part (c) of FIG. 17). Thereafter, for the pages P6 to P10 (sheet type C), the process in S202 proceeds to S203, then proceeds to the flow for determining the target temperature for when all of the pages are the same sheet type. Further, in the example in FIG. 8, since S219 is not passed and the target temperature maintenance flag information is not set, the process proceeds to S206 by the determination in S205.

In S206, the CPU 901 determines whether or not the temperature switching operation flag information [1] in the control data is 0; if it is 0, the CPU 901 proceeds to S207, and if it is not 0, the CPU 901 proceeds to S208. In the example in FIG. 8, a flag is set for the page P6 in S220 (i.e., the temperature switching operation flag information is 1), so the process proceeds to S208.

In S208, the CPU 901 stores the central value between the lower limit value and the upper limit value of the fixing temperature range for the sheet type stored in the sheet type information [N] in the target temperature information [N], then proceeds to S210.

In the example in FIG. 8, by executing S208 to S211 for the pages P6 to P10, the target temperature for the page P6 is set at 173° C., and all of the target temperatures for the pages P7 to P10 are set at 176° C. (part (d) of FIG. 17).

Thereafter, the same steps as for the pages P1 to P5 (sheet type A) are executed for the pages P6 to P10 (sheet type C), then S224 is executed.

In the example in FIG. 8, by repeating the steps described above until there is no data left in the storage area in the control data, the target temperatures of the pages P1 to P5 are ultimately set at the same 168° C., and the target temperature of the page P6, which performs the temperature switching operation, is set at 173° C. For the pages P7 to P10, the set temperature is changed stepwise by increments of 1° C., as shown in parts (e), (f), (g), and (h) of FIG. 17, in order to reach the last target temperature (176° C.) through the flow of the temperature change upper limit checking process.

### Flow of Temperature Change Upper Limit Checking Process

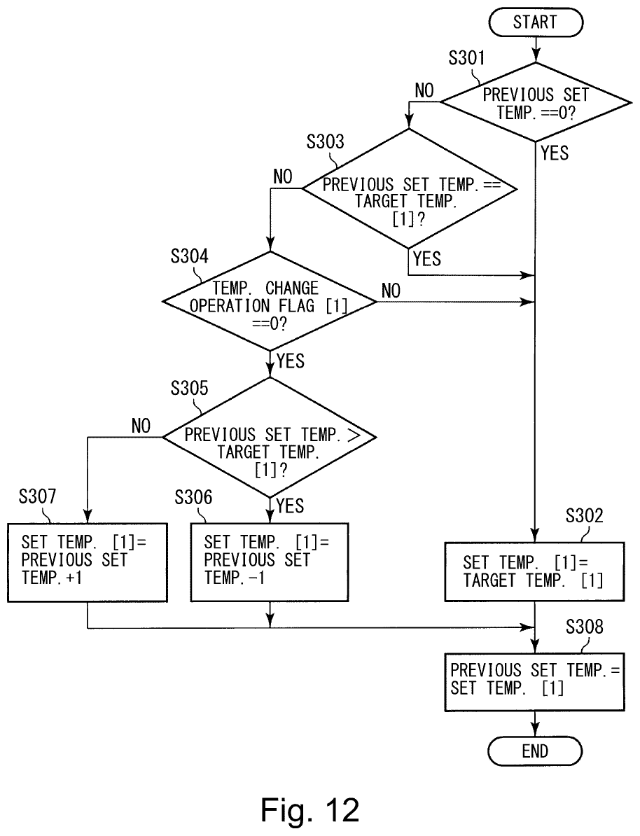

Next, the flow of the temperature change upper limit checking process will be described with reference to FIG. 12. The processes shown in FIG. 12 are executed by the CPU 901. The temperature change upper limit checking process is a process for determining the final set temperature from the target temperature determined in the set temperature determining process.

In S301, the CPU 901 determines whether or not the previously set temperature information is 0; if it is 0, the CPU 901 proceeds to S302, and if it is not 0, the CPU 901 proceeds to S303.

In S302, the CPU 901 sets the information on the target temperature information to set temperature information [1] (i.e., determines the set temperature), then proceeds to S308.

In S303, the CPU 901 compares the previously set temperature information with the target temperature information [1]; if the values are the same, the process proceeds to S302, and if the values are different, the process proceeds to S304.

In S304, the CPU 901 determines whether or not the temperature switching operation flag information [1] is 0; if it is 0, the CPU 901 proceeds to S305, and if it is not 0, the CPU 901 proceeds to S302.

In S305, the CPU 901 compares the previously set temperature information with the target temperature information [1]; if the previously set temperature information is greater (higher) than the target temperature information [1], the CPU 901 proceeds to S306; otherwise, the CPU 901 proceeds to S307.

In S306, the CPU 901 sets the value of the previously set temperature information−1 (° C.) to the set temperature information [1] (i.e., determines the set temperature), then proceeds to S308.

In S307, the CPU 901 sets the value of the previously set temperature information [1]+1 (° C.) to the set temperature information [1] (i.e., determines the set temperature), then proceeds to S308.

As described with reference to FIG. 9, the processes in S306 and S307 limit the change width of the fixing temperature to the change upper limit temperature, and the fixing temperature is changed stepwise by increments of 1° C. toward the target temperature.

In S308, the CPU 901 updates the previously set temperature information to the set temperature information [1], and ends the flow of the temperature change upper limit checking process.

In the example of the pattern with the same sheet type in FIG. 5, for the page P1, the previously set temperature information is 0 in S301, so the process proceeds to S302, and in S302, the set temperature information is determined to be the target temperature (164° C.). Further, in S308, the previously set temperature information is updated to 164° C. For the pages P2 to P10, in S301, the previously set temperature information is 164° C., so the process proceeds to S303, then proceeds from S303 to S302, and in S302, the set temperature information is determined to be the target temperature (164° C.). Further, in S308, the previously set temperature information is updated to 164° C.

In the example of the pattern with different sheet types and the overlapped fixing temperature range in FIG. 7, for the page P1, in S301, the previously set temperature information is 0, so the process proceeds to S302, and in S302, the set temperature information is determined to be the target temperature (167° C.). Further, in S308, the previously set temperature information is updated to 167° C. For the pages P2 to P10, in S301, the previously set temperature information is 167° C., so the process proceeds to S303, then proceeds from S303 to S302, and in S302, the set temperature information is determined to be the target temperature (167° C.). Further, in S308, the previously set temperature information is updated to 167° C.

In the example of the pattern with different sheet types and the non-overlapped fixing temperature range in FIG. 8, for the page P1, in S301, the previously set temperature information is 0, so the process proceeds to S302, and in S302, the set temperature information is determined to be the target temperature (168° C.). Further, in S308, the previously set temperature information is updated to 168° C. For the pages P2 to P5, in S301, the previously set temperature information is 168° C., so the process proceeds to S303, then proceeds from S303 to S302, and in S302, the set temperature information is determined to be the target temperature (168° C.). Further, in S308, the previously set temperature information is updated to 168° C. For the page P6, in S301, the previously set temperature information is 168° C., so the process proceeds to S303, then proceeds from S303 to S304. Further, since the temperature switching operation flag is set, as a result of the determination in S304, the process proceeds to S302, and the set temperature information is determined to be the target temperature (173° C.). Further, in S308, the previously set temperature information is updated to 173° C. For the pages P7 to P10, in S301, the previously set temperature information is 168° C., so the process proceeds to S303, then proceeds from S303 to S304. Further, since the temperature switching operation flag is not set, as a result of the determination in S304, the process proceeds to S305. In S305, since the previously set temperature for the page P6 is 173° C., and the target temperature information on the page P7 is 176° C., the process proceeds to S307. In S307, the set temperature information is determined to be 174° C., which is the previously set temperature (173° C.) plus 1 (° C.). Further, in S308, the previously set temperature information is updated to 174° C.

By executing the same steps for the pages P8 to P10, the set temperature is determined to be 175° C. for the page P8 and 176° C. for the pages P9 to P10.

### Pattern for Outputting More Than 10 Pages

Next, the flow of the prefetching fixing control will be described using the job described with reference to FIG. 9 as an example of the pattern for outputting more than 10 pages.

For the pages P1 to P10 in FIG. 9, S101 to S106 in FIG. 10 are executed, and when S106 is executed for the first time, the information on the 10 pages P1 to P10 (sheet type A) is stored in the storage area in the control data.

When S106 in FIG. 10 is executed and the flow in FIG. 11 is started, S201 to S211 are repeated so that S207 is executed, and 164° C., which is the central value of the fixing temperature range for the sheet type A, is set as the target temperature for the pages P1 to P10. Further, when S224 is executed, the fixing temperature for the page P1 (sheet type A) is ultimately set at 164° C., and in S225, the data for the page P1 is erased from the storage area in the control data. Further, in S226, it is determined whether or not there is data received for the last page information, and since the last page information has not been received, the flow in FIG. 11 is exited and returned to the flow in FIG. 10.

The process proceeds to S108 in FIG. 10, and since the set temperature for the last page has not been determined in S108, the process proceeds to S109. In S109, when the page information on the page P11 (sheet type B) is received, the data for the page P11 is stored in the storage area for the page number information 10 in the control data in S110, and S106 is executed.

When S106 in FIG. 10 is executed, the flow in FIG. 11 is started, and S203 to S211 are executed, for the pages P2 to P10 (sheet type A), S207 is executed and the target temperature is set at 164° C. For the page P11 (sheet type B), the process proceeds to the flow in S212 to S219 for determining the target temperature when there are different sheet types. Since there is the overlapped fixing temperature range for the page P2 (sheet type A) and the page P11 (sheet type B), by executing S218, the target temperature for the pages P2 to P10 (sheet type A) and the page P11 (sheet type B) is set at 167° C.

Further, for the page P2 (sheet type A), through the flow in the temperature change upper limit checking process in S224, the target temperature of the page P2 (sheet type A) is 167° C., while the previously set value of the page P1 (sheet type A) is 164° C., so the temperature change upper limit process is activated. As a result, the fixing temperature for the page P2 (sheet type A) is ultimately set at 165° C.

By executing the above steps each time new pages P12 and P13 (sheet type B) are added, the fixing temperature for the page P3 is set at 166° C., and the fixing temperature for the page P4 (and the pages P5 to P13) is set at 167° C.

Thus, in this embodiment, the image forming apparatus 10 comprises: the image forming portion 150 configured to form the toner image on the recording material; the fixing portion 117 configured to apply heat to the recording material on which the toner image is formed and to fix the toner image on the recording material; the storage portion (ROM) 902 in which information on the target temperature of the fixing portion 117 is stored corresponding to the type of the recording material; the acquiring portions (external I/F 904, operation display device controller 941) configured to acquire the information on the type of the recording material on which the toner image is formed; and the controller (CPU) 901 configured to set the target temperature required to fix the toner image on the recording material based on the information on the type acquired by the acquiring portions 904 and 941 and the information on the target temperature stored in the storage portion. Further, in this embodiment, in the storage portion 902, the information on the temperature range from the lower limit value to the upper limit value of the target temperature is stored corresponding to the type of the recording material, and the controller 901, when executing the job for forming the toner image on a plurality of recording materials including a first recording material (for example, the P5 in FIG. 7) of a first type and a second recording material (for example, the P6 in FIG. 7), succeeding to the first recording material, of a second type, before the toner image is formed on the first and the second recording materials, acquires the information on the types of the first and the second recording materials and acquires the information on a first temperature range which is the temperature range corresponding to the first type and a second temperature range which is the temperature range corresponding to the second type, and in a case in which there is the overlapped temperature range where the first temperature range and the second temperature range overlap each other, the controller 901 sets the target temperature at a temperature within the overlapped temperature range.

Further, in this embodiment, in a case in which there is not the overlapped temperature range where the first temperature range and the second temperature range overlap each other and the lower limit value of the second temperature range is higher than the upper limit value of the first temperature range ((5) in FIG. 6), the controller 901 sets the target temperature while fixing the toner image on the first recording material (for example, the P5 in FIG. 8) at the upper limit value of the first temperature range and sets the target temperature while fixing the toner image on the second recording material (for example, the P6 in FIG. 8) at the lower limit value of the second temperature range. Further, in this embodiment, in a case in which there is not the overlapped temperature range where the first temperature range and the second temperature range overlap each other and the upper limit value of the second temperature range is lower than the lower limit value of the first temperature range ((6) in FIG. 6), the controller 901 sets the target temperature while fixing the toner image on the first recording material at the lower limit value of the first temperature range and sets the target temperature while fixing the toner image on the second recording material at the upper limit value of the second temperature range.

Further, the controller 901, when executing a job for forming the toner image on a plurality of recording materials including a third recording material (for example, the P5 in FIG. 8) of the first type, a fourth recording material (for example, the P6 in FIG. 8), succeeding to the third recording material, of the second type and a fifth recording material (for example, the P7 in FIG. 8), succeeding to the fourth recording material, of the second type, before the toner image is formed on the third, the fourth and the fifth recording materials, acquires the information on the types of the third, the fourth and the fifth recording materials and acquires the information on the first temperature range corresponding to the first type and the second temperature range corresponding to the second type, and in a case in which there is not the overlapped temperature range where the first temperature range and the second temperature range overlap each other and the lower limit value of the second temperature range is higher than the upper limit value of the first temperature range, the controller 901 sets the target temperature while fixing the toner image on the third recording material at the upper limit value of the first temperature range, sets the target temperature while fixing the toner image on the fourth recording material at the lower limit value of the second temperature range, and sets the target temperature while fixing the toner image on the fifth recording material at a temperature within the second temperature range and higher than the lower limit value of the second temperature range. In this case, the controller 901 makes a difference between the target temperature while fixing the toner image on the fourth recording material and the target temperature while fixing the toner image on the fifth recording material equal to or less than a predetermined value. Incidentally, the same applies when the upper limit value of the second temperature range is lower than the lower limit value of the first temperature range. In this case, the target temperature while fixing the toner image to the fifth recording material can be set at a temperature within the second temperature range that is lower than the upper limit value of the second temperature range, and the difference can be set at the predetermined value or less. Further, the controller 901, when executing a job for continuously forming the toner image on a plurality of third recording materials of the first type, before the toner image is formed on the third recording materials, acquires the information on the type of the third recording materials and acquires the information on the first temperature range corresponding to the first type, and the controller 901 sets the target temperature while fixing the toner image on the third recording materials at a temperature within the first temperature range.

Further, the controller 901, when executing a job for forming the toner image on a plurality of recording materials including the third recording material (for example, the P8 in FIG. 9) of the first type, the fourth recording material (for example, the P9 in FIG. 9), succeeding to the third recording material, of the first type, the fifth recording material (for example, the P10 in FIG. 9), succeeding to the fourth recording material, of the first type and the sixth recording material (for example, the P11 in FIG. 9), succeeding to the fifth recording material, of the second type, before the toner image is formed on the third and the fourth recording materials, acquires the information on the types of the third and fourth recording materials and acquires the information on the first temperature range corresponding to the first type, and sets the target temperature while fixing the toner image on the third recording material within the first temperature range. Further, the controller 901, before the toner image is formed on the fourth, the fifth and the sixth recording materials, acquires the information on the types of the fourth, the fifth and the sixth recording materials and acquires the information on the first temperature range corresponding to the first type and the information on the second temperature range corresponding to the second type, and sets the target temperature while fixing the toner image on the fourth, the fifth and the sixth recording materials at a temperature within the overlapped temperature range in the case in which there is the overlapped temperature range. At this time, the controller 901 sets the target temperature while fixing the toner image on the fifth recording material at a temperature higher than the target temperature while fixing the toner image on the fourth recording material and lower than the target temperature while fixing the toner image on the sixth recording material when the upper limit value of the second temperature range is higher than the upper limit value of the first temperature range.

Further, at this time, the controller 901 sets the target temperature while fixing the toner image on the fifth recording material at a temperature lower than the target temperature while fixing the toner image on the fourth recording material and higher than the target temperature while fixing the toner image on the sixth recording material when the lower limit value of the second temperature range is lower than the lower limit value of the first temperature range. In this case, the controller 901 makes a difference between the target temperature while fixing the toner image on the fourth recording material and the target temperature while fixing the toner image on the fifth recording material and a difference between the target temperature while fixing the toner image on the fifth recording material and the target temperature while fixing the toner image on the sixth recording material equal to or lower than the predetermined value.

As described above, according to this embodiment, unlike the method of selecting a target temperature table to be used from a plurality of target temperature tables, by setting an allowable fixing temperature range for each sheet type, it is possible to accommodate for an arbitrary combination of sheet types. This makes it possible to utilize the allowable fixing temperature range for each sheet type to the fullest extent and suppress the occurrence of the waiting time caused by the temperature switching operation. Therefore, according to this embodiment, it is possible to suppress the occurrence of the waiting time caused by the temperature switching operation when executing a job in which recording materials of different types are mixed, thereby improving productivity.

### Other

Although the present invention has been described with reference to specific embodiments, the present invention is not limited to the embodiments described above.

In the above embodiments, the image forming apparatus is a monochrome image forming apparatus, but the image forming apparatus may be, for example, a color image forming apparatus capable of forming a full-color image. Further, the image forming apparatus may be, for example, a copier, a printer, a facsimile machine, a multifunction printer having a plurality of these functions, a printing machine, or the like.

Further, in the above embodiments, information on the type of the recording material is acquired from an external device such as the operation display device of the image forming apparatus or a computer based on an operation by the operator, but the information on the type of the recording material may also be acquired based on the detection result of a sensor capable of detecting aspects of the recording material such as thickness or surface properties.

According to the present invention, it is possible to suppress the occurrence of the waiting time caused by the temperature switching operation when executing a job in which recording materials of different types are mixed, thereby improving productivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-027418, filed Feb. 21, 2025, which is hereby incorporated by reference herein in its entirety.

What is claimed is:

1. An image forming apparatus comprising:
an image forming portion configured to form a toner image on a recording material;
a fixing portion configured to apply heat to the recording material on which the toner image is formed and to fix the toner image onto the recording material;
a storage portion in which information on a target temperature of the fixing portion is stored corresponding to a type of the recording material;
an acquiring portion configured to acquire the information on the type of the recording material on which the toner image is formed; and
a controller configured to set the target temperature required to fix the toner image on the recording material based on the information on the type acquired by the acquiring portion and the information on the target temperature stored in the storage portion,
wherein in the storage portion, information on a temperature range from a lower limit value to an upper limit value of the target temperature is stored corresponding to the type of the recording material, and
wherein the controller, when executing a job for forming the toner image on a plurality of recording materials including a first recording material of a first type and a second recording material, succeeding to the first recording material, of a second type, before the toner image is formed on the first and the second recording materials, acquires the information on the types of the first and the second recording material and acquires the information on a first temperature range which is the temperature range corresponding to the first type and a second temperature range which is the temperature range corresponding to the second type, and
wherein the controller sets the target temperature at a temperature within the overlapped temperature range in a case in which there is an overlapped temperature range where the first temperature range and the second temperature range overlap each other.

2. The image forming apparatus according to claim 1, wherein in a case in which there is not the overlapped temperature range where the first temperature range and the second temperature range overlap each other and the lower limit value of the second temperature range is higher than the upper limit value of the first temperature range, the controller sets the target temperature while fixing the toner image on the first recording material at the upper limit value of the first temperature range and sets the target temperature while fixing the toner image on the second recording material at the lower limit value of the second temperature range.

3. The image forming apparatus according to claim 1, wherein in a case in which there is not the overlapped temperature range where the first temperature range and the second temperature range overlap each other and the upper limit value of the second temperature range is lower than the lower limit value of the first temperature range, the controller sets the target temperature while fixing the toner image on the first recording material at the lower limit value of the first temperature range and sets the target temperature while fixing the toner image on the second recording material at the upper limit value of the second temperature range.

4. The image forming apparatus according to claim 1, wherein the controller, when executing a job for forming the toner image on a plurality of recording materials including a third recording material of the first type, a fourth recording material, succeeding to the third recording material, of the second type and a fifth recording material, succeeding to the fourth recording material, of the second type, before the toner image is formed on the third, the fourth and the fifth recording materials, acquires the information on the types of the third, the fourth and the fifth recording material and acquires the information on the first temperature range corresponding to the first type and the second temperature range corresponding to the second type, and
in a case in which there is not the overlapped temperature range where the first temperature range and the second temperature range overlap each other and the lower limit value of the second temperature range is higher than the upper limit value of the first temperature range, the controller sets the target temperature while fixing the toner image on the third recording material at the upper limit value of the first temperature range, sets the target temperature while fixing the toner image on the fourth recording material at the lower limit value of the second temperature range, and sets the target temperature while fixing the toner image on the fifth recording material at a temperature within the second temperature range and higher than the lower limit value of the second temperature range.

5. The image forming apparatus according to claim 4, wherein the controller makes a difference between the target temperature while fixing the toner image on the fourth recording material and the target temperature while fixing the toner image on the fifth recording material equal to or less than a predetermined value.

6. The image forming apparatus according to claim 1, wherein the controller, when executing a job for forming the toner image on a plurality of recording materials including a third recording material of the first type, a fourth recording material, succeeding to the third recording material, of the second type and a fifth recording material, succeeding to the fourth recording material, of the second type, before the toner image is formed on the third, the fourth and the fifth recording materials, acquires the information on the types of the third, the fourth and the fifth recording materials and acquires the information on the first temperature range corresponding to the first type and the second temperature range corresponding to the second type, and
in a case in which there is not the overlapped temperature range where the first temperature range and the second temperature range overlap each other and the upper limit value of the second temperature range is lower than the lower limit value of the first temperature range, the controller sets the target temperature while fixing the toner image on the third recording material at the lower limit value of the first temperature range, sets the target temperature while fixing the toner image on the fourth recording material at the upper limit value of the second temperature range, and sets the target temperature while fixing the toner image on the fifth recording material at a temperature within the second temperature range and lower than the upper limit value of the second temperature range.

7. The image forming apparatus according to claim 6, wherein the controller makes a difference between the target temperature while fixing the toner image on the fourth recording material and the target temperature while fixing the toner image on the fifth recording material equal to or less than a predetermined value.

8. The image forming apparatus according to claim 1, wherein the controller, when executing a job for continuously forming the toner image on a plurality of third recording materials of the first type, before the toner image is formed on the third recording materials, acquires the information on the type of the third recording materials and acquires the information on the first temperature range corresponding to the first type, and
the controller sets the target temperature while fixing the toner image on the third recording materials at a temperature within the first temperature range.

9. The image forming apparatus according to claim 1, wherein the controller, when executing a job for forming the toner image on a plurality of recording materials including a third recording material of the first type, a fourth recording material, succeeding to the third recording material, of the first type, a fifth recording material, succeeding to the fourth recording material, of the first type and a sixth recording material, succeeding to the fifth recording material, of the first type,
before the toner image is formed on the third and the fourth recording materials, acquires the information on the types of the third and fourth recording materials and acquires the information on the first temperature range corresponding to the first type, and sets the target temperature while fixing the toner image on the third recording material within the first temperature range,
before the toner image is formed on the fourth, the fifth and the sixth recording materials, acquires the information on the types of the fourth, the fifth and the sixth recording materials and acquires the information on the first temperature range corresponding to the first type and he information on the second temperature range corresponding to the second type, and sets the target temperature while fixing the toner image on the fourth, the fifth and the sixth recording materials at a temperature within the overlapped temperature range in a case in which there is the overlapped temperature range, and
sets the target temperature while fixing the toner image on the fifth recording material at a temperature higher than the target temperature while fixing the toner image on the fourth recording material and lower than the target temperature while fixing the toner image on the sixth recording material when the upper limit value of the second temperature range is higher than the upper limit value of the first temperature range, and sets the target temperature while fixing the toner image on the fifth recording material at a temperature lower than the target temperature while fixing the toner image on the fourth recording material and higher than the target temperature while fixing the toner image on the sixth recording material when the lower limit value of the second temperature range lower than the lower limit value of the first temperature range.

10. The image forming apparatus according to claim 9, wherein the controller makes a difference between the target temperature while fixing the toner image on the fourth recording material and the target temperature while fixing the toner image on the fifth recording material and a difference between the target temperature while fixing the toner image on the fifth recording material and the target temperature while fixing the toner image on the sixth recording material equal to or lower than a predetermined value.
